(19) United States
(12) Patent Application Publication
(10) Pub. No.: US 2014/0278143 A1
(43) Pub. Date: Sep. 18, 2014

(54) METHOD FOR PERFORMING QUANTITATION ASSAYS

(71) Applicant: CURIOSITY DIAGNOSTICS SP. Z.O.O., Warsaw (PL)

(72) Inventors: Piotr Garstecki, Warsaw (PL); Pawel Rafal Debski, Warsaw (PL); Michal Oszmaniec, Warsaw (PL); Tomasz Kaminski, Wilkolaz (PL); Adam Warchulski, Milanowek (PL)

(73) Assignee: CURIOSITY DIAGNOSICS SP.ZOO, Warsaw (PL)

(21) Appl. No.: 14/344,046

(22) PCT Filed: Nov. 19, 2012
(86) PCT No.: PCT/EP2012/004792

§ 371 Date: Mar. 10, 2014

(30) Foreign Application Priority Data
Nov. 17, 2011 (PL) 297027
Nov. 17, 2011 (PL) 397026
Nov. 17, 2011 (PL) 397028
Jun. 26, 2012 (PL) 399673
Jul. 11, 2012 (PL) 399908

(51) Int. Cl. G01N 15/06

(52) U.S. Cl. CPC G01N 15/06
USPC 702/23

(57) ABSTRACT

The present invention relates to a method for determining an estimate of a concentration of particles E(C), wherein a sample of predetermined volume is divided into a number (N) of compartments, the (N) compartments comprise or consist of different sample volumes (v₁) and/or different dilution factors (dᵢ) of the sample, at least part of the particles that are present in any of the (N) compartments provide a measurable signal and the estimated concentration of particles E(C) is a function of measured signals, as well as an apparatus for use in the inventive method, uses of the inventive method, a sample holder and a kit for use in the inventive method.

### TECHNICAL FIELD

The present invention relates to a method for determining an estimate of a concentration of particles E(C), wherein a sample of predetermined volume is divided into a number (N) of compartments, the (N) compartments comprise or consist of different sample volumes (vᵢ) and/or different dilution factors (dᵢ) of the sample, at least part of the particles that are present in any of the (N) compartments provide a measurable signal and the estimated concentration of particles E(C) is a function of measured signals, as well as an apparatus for use in the inventive method, uses of the inventive method, a sample holder and a kit for use in the inventive method.

### BACKGROUND ART

In analytical chemistry the standard (or ‘analogue’) method to quantify the concentration of an analyte particle is to calibrate how it relates to a measurable amplitude of a physical quantity, e.g. the absorbance of light passing through the sample. The estimate E(C) of the concentration C of the analyte particles is then retrieved as function of the signal.

The Polymerase Chain Reaction (PCR) comprises one method of the prior art for quantifying concentration of nucleic acids. The PCR procedure generally allows for replicating fragments of DNA chains. Typically, the length of a replicated fragment does not exceed 10 thousand base pairs (bp), and in the quantitative PCR usually a shorter fragments are replicated. According to methods of the prior art the replicated DNA copies are labelled, for instance, with fluorescent dyes displaying strong fluorescence only after complex formation with a double-stranded DNA (dye-DNA complex)—for example SYBR Green or EvaGreen. [Advan. Physiol. Educ. 29:151-159, 2005]—to provide a measureable signal (fluorescence level). The fluorescence level increases proportionally with multiplication of the DNA fragment.

When target DNA fragments are present in the sample, their number increases very rapidly during the PCR process—geometrically as a function of the number of completed cycles. Fast increase of the number of copies is attractive in preparative applications and in qualitative diagnostic assays aiming at detecting the presence of the target DNA (for instance, as a proof for the presence of specific microorganisms in the sample). At the same time, the exponential growth (as a function of the number of cycles) of replications of the target DNA significantly hampers the assay of the initial number of target DNA copies in the sample before the PCR process was carried out. According to the prior art, the so called real-time PCR, provides methods, where fluorescence activity of the sample (i.e., signal intensity) is monitored after each PCR cycle, and subsequently the initial DNA concentration in the sample is approximated by comparing fluorescence intensity from the sample as a function of time with calibration curves. The accuracy of these procedures is limited. Their additional drawback is that additional comparative (reference) experiments must be performed for each quantitation.

In 1999 Vogelstein and Kinzler proposed a digital assay that uses the ability of the observer to detect a binary stochastic function k(C) adopting either a positive value (k=1) when the inspected volume happens to contain at least one analyte particle or a negative value (k=0) otherwise. The concentration is estimated on the basis of the fraction of ‘positive’ compartments (i.e. ones that yield k=1). As the assays require strong amplification of the presence of the analyte particle, their key applications are generally in quantitative PCR or Enzyme Linked Immunosorbent Assay (ELISA).

According to a digital PCR method of the prior art, a PCR mixture (sample and reagents) with a total volume V is partitioned into N compartments with equal volumes v=V/N. Then, PCR reaction cycles are carried out in all compartments (preferably simultaneously), e.g. by cyclic variation of temperature. Subsequently, typically fluorescence intensity is measured after completion of the PCR process (endpoint measurements) separately for each compartment, and to the number of compartments, where the reaction is completed, the compartments that yield a ‘positive’ signal are counted and the number of positive compartments K together with N are used to calculate the estimate E(M) of the actual initial number M of target DNA copies in the tested sample.

The development of the concept of digital assay offered a new paradigm in analytical chemistry. It allows the absolute quantification without calibration of the experimental set-up. Also, it benefits from simplified laboratory routines, i.e. end-point measurement, and relatively plain mathematical tools needed to interpret the experimental results. The digital assays of the prior art are, however, affected by limitations.

1. The maximum number of analyte particles M to be determined is directly proportional to the number N of compartments in the assay. In many applications and potential applications of diagnostic quantitation assays it is preferred that the span of the dynamic range (Ω=C⁺/C⁻ (with C⁺ representing the upper limit and C⁻ representing the lower limit of estimated concentration of analyte particles in the assay) is large, for instance is equal to 1 million or more. To reach such a large span of the dynamic range in a standard digital PCR procedure, the sample must be partitioned into proportionally large number of compartments—in the said example—according to the state of knowledge in the field that overlooks unfavourably small precision at very small concentrations, into as many as 200,000 compartments or—actually—as shown in the description below, even 600,000 compartments. Partitioning a sample into such a huge number of compartments is although possible unfavourable, as such an assay requires specialized, complicated and expensive equipment to be performed. In particular, design of assays that aim to partition, amplify and inspect tens of thousands, or hundreds of thousands or millions of compartments require expensive technologies of micro-fabrication, automation and rapid and sensitive detection from multiple small volumes.

Furthermore, the precision and dynamic range achieved by the digital assays of the prior art cannot be independently tuned narrowing the range of applications and elevating the technical cost of the assays. Thus, it is not possible to obtain high precision (low standard deviation) in a narrow range of concentrations while using a small number N of compartments using digital assays of the prior art.

The prior art provides a solution to increase the span of the dynamic range of the assay and reducing the number of compartments by combining classical digital quantitation assays with different dynamic ranges [Shen, F.; Sun, B.; Kreutz, J. E.; Davydova, E. K.; Du, W.; Reddy P. L.; Joseph, L. J.; Ismagilov, R. F., “Multiplexed Quantification of Nucleic Acids with Large Dynamic Range Using Multivolume Digital RT-PCR on a Rotational SlipChip Tested with HIV and Hepatitis C Viral Load”, J. Am. Chem. Soc., Article ASAP (X 2011)]. The solution relies on a simultaneously performed assay for multiple sets of compartments. The compartments belonging to each set have the same volume. In the cited example, N_{z}=4 sets are used with Nⱼ=160 compartments each (j=1 to 4), with volumes of compartments equal to vⱼ=1, 5, 25 and 125 nL in each of four sets. The procedure consists in i) dividing the samples into sets and compartments, ii) performing simultaneously signal amplification, iii) counting separately the number Kⱼ of positive signals in each of N_{z} sets and iv) calculating the most probable initial concentration of particles in the sample. The calculation is laborious and demanding, because of the requirement to calculate repeatedly the product

$${\prod }_{j = 1}^{{N}_{z}} \{ {{[ \frac{{N}_{j} !}{{K}_{j} ! ( {N}_{j} - {K}_{j} ) !} ] [ 1 - exp ( - {v}_{j} C ) ]}^{{K}_{j}} [ exp ( - {v}_{j} C ) ]}^{{N}_{j} - {K}_{j}} \} ,$$

where the multiplication operator Πⱼ₌₁^{N}^{_{z}} denotes the product of N_{z} terms calculated for each of N_{z} compartment families, each term comprising the probability of observing Kⱼ positive signals from the j-th family. Computation of the result requires an iterative calculation of the said product for each tested, hypothetical value of C within the test dynamic range, until a value C is found for which the above product assumes the maximum. The above procedure must be repeated after each measurement of signals from the sample, which hinders the analysis of the test result, requires a sufficiently fast electronic device or elongates the time needed to obtain the estimate of the number of particles in the sample. The above procedure would be in particular definitely unfavourable in the case of a large number (e.g. ten, or few tens, or hundred or more) of sets of compartments, characterised by that the compartments have the same volume within one set, but different volumes for each two different sets.

Furthermore, WO 2012/100198 A2 discloses methods for performing digital measurements with varying volumes and, thus, widening the dynamic range.

Although the aforementioned digital assays provide an increase in the dynamic range, the analysis is very laborious and the number of compartments is still high. Accordingly, it would be desirable to provide a method which is easier to be analyzed and which allows to use a smaller number of compartments to decrease the technological requirements for preparation of the sample holder, for the procedure of partitioning the sample, amplification and detection, for the apparatus that realizes these tasks and for the analysis of the result of the assay.

Accordingly, there exists a need of providing an improved method for determining an estimate of a concentration of particles E(C), wherein the desired dynamic range and the desired precision of the assay can be independently tuned, and/or the mathematical analysis is easier, and/or wherein for a predetermined dynamic range and a predetermined standard deviation
a) the total number (N) of compartments comprising the predetermined sample volume can be adjusted, preferably reduced and/or
b) the total volume of a mixture comprising or consisting of sample, one or more reagents suitable for amplifying at least part of the particles to a measurable signal and optionally one or more diluents in all of the (N) compartments can be adjusted, preferably reduced and/or
c) the volume, preferably the minimum or maximum volume of the mixture comprising or consisting of sample, one or more reagents suitable for amplifying at least part of the particles to a measurable signal and optionally one or more diluents in each of the (N) compartments can be predetermined.

### BRIEF DESCRIPTION OF THE INVENTION

The aforementioned needs are met in part or all by means of the claimed inventive subject matter. Preferred embodiments are in particular described in the dependent claims, the detailed description and/or the accompanying figures.

Accordingly a first aspect of the invention relates to a method for determining an estimate of a concentration of particles E(C), wherein a sample of predetermined volume is divided into a number (N) of compartments, at least part of the particles that are present in any of the (N) compartments provide a measurable signal and the estimated concentration of particles E(C) is a function of measured signals, characterized in that the method comprises or consists of

a) determining the number (N) of separate compartments, wherein the number (N) is smaller or equal to the value of the function

$${N}_{MAX} = A \cdot ln ( \frac{{C}^{+}}{{C}^{-}} ) / {σ}_{MAX}^{2}$$

wherein (A) represents a real number being the integer 6, wherein (C⁺) represents a predetermined upper limit of the interval of concentration (C) to be estimated by the method, wherein (C⁻) represents a predetermined lower limit of the interval of concentration (C) to be estimated by the method, wherein (σ_{MAX}) represents a predetermined maximum allowable relative standard deviation of the estimate of concentration (C) of particles, wherein C⁻<C<C⁺, and

b) determining a modulation factor (zᵢ), wherein (zᵢ) is a function of volumes (vᵢ) and dilution factors (dᵢ) of the sample in at least part of or all of the (N) compartments and partitioning the sample into the (N) compartments, wherein at least part of or all of the two or more of the (N) compartments comprise or consist of different sample volumes (vᵢ) and/or different dilution factors (dᵢ) of the sample, wherein (i) represents an index number of the (N) compartments represented by the integers 0 to N−1, and wherein (vᵢ) represents the volume and (dᵢ) represents the dilution factor of the sample in the compartment (i).

Accordingly a second aspect of the invention relates to an apparatus for use in determining a concentration of particles in accordance with the inventive method characterized in that the apparatus is configured to

a) determining a number (N) of separate compartments, wherein the number (N) is smaller or equal to the value of the function

$${N}_{MAX} = A \cdot ln ( \frac{{C}^{+}}{{C}^{-}} ) / {σ}_{MAX}^{2}$$

wherein (A) represents a real number being the integer 6, Wherein (C⁺) represents a predetermined upper limit of the interval of concentration (C) to be estimated by the method, Wherein (C⁻) represents a predetermined lower limit of the interval of concentration (C) to be estimated by the method, Wherein (σ_{MAX}) represents a predetermined maximum allowable relative standard deviation of the estimate of concentration (C) of particles, wherein C⁻<C<C⁺, and

b) determining a modulation factor (zᵢ), wherein (zᵢ) is a function of volumes (vᵢ) and dilution factors (dᵢ) of the sample in at least part of or all of the (N) compartments so that at least part of or all of the two or more of the (N) compartments comprise or consist of different sample volumes (vᵢ) and/or different dilution factors (dᵢ) of the sample, wherein (i) represents an index number of the (N) compartments represented by the integers 0 to N−1, and wherein (vᵢ) represents the volume and (dᵢ) represents the dilution factor of the sample of predetermined volume in the compartment (i).

Accordingly a third aspect of the invention relates to a use of the inventive method or the inventive apparatus for

a) adjusting, preferably reducing the total number (N) of compartments comprising the predetermined sample volume and/or

b) adjusting, preferably reducing the total volume of a mixture comprising or consisting of sample, one or more reagents suitable for amplifying at least part of the particles to a measurable signal and optionally one or more diluents in all of the (N) compartments and/or

c) predetermining the volume, preferably the minimum or maximum volume of the mixture comprising or consisting of sample, one or more reagents suitable for amplifying at least part of the particles to a measurable signal and optionally one or more diluents in each of the (N) compartments and/or

d) predetermining the modulation factor (zᵢ), preferably the minimum or the maximum suitable modulation factor (zᵢ) for partitioning the predetermined sample volume into the (N) compartments.

Accordingly a fourth aspect of the invention relates to a sample holder for use in an inventive method, characterized in that the sample holder is configured to,

a) comprising or consisting of a predetermined number (N) of compartments wherein the number (N) is smaller or equal to the value of the function

$${N}_{MAX} = A \cdot ln ( \frac{{C}^{+}}{{C}^{-}} ) / {σ}_{MAX}^{2}$$

wherein (A) represents a real number being the integer 6, Wherein (C⁺) represents a predetermined upper limit of the interval of concentration (C) to be estimated by the method, Wherein (C⁻) represents a predetermined lower limit of the interval of concentration (C) to be estimated by the method, Wherein (σ_{MAX}) represents a predetermined maximum allowable relative standard deviation of the estimate of concentration (C) of particles, wherein C⁻<C<C⁺, and

b) wherein the (N) compartments are configured to comprising the predetermined sample volume with a predetermined modulation factor (zᵢ), wherein (zᵢ) is a function of volumes (vᵢ) and dilution factors (dᵢ) of the sample in at least part of or all of the (N) compartments so that at least part of or all of the two or more of the (N) compartments can comprise or consist of different sample volumes (vᵢ) and/or different dilution factors (dᵢ) of the sample, wherein (i) represents an index number of the (N) compartments represented by the integers 0 to N−1, and wherein (vᵢ) represents the volume and (dᵢ) represents the dilution factor of the sample in the compartment (i).

Accordingly a fifth aspect of the invention relates to a kit comprising the inventive sample holder and one or more reagents suitable for amplifying at least part of particles comprised in the compartments of the sample holder to a measurable signal and optionally one or more suitable diluents for determining a concentration of particles, preferably for determining the concentration of particles in accordance with the inventive method.

The aforementioned inventive embodiments can—as far it is reasonable in view of a technical expert—comprise any possible combination of the preferred inventive embodiments, which are disclosed in the following and in particular in the dependent claims.

### BRIEF DESCRIPTION OF THE DRAWINGS

FIGS. 1a), 1b) and 1c): Graphs displaying the combinations of the dynamic range and precision that can be achieved with assays comprising identical compartments and the inventive method, comparison of the number N of compartments required to yield a given dynamic range and precision in accordance with the present invention.

FIGS. 2a) and 2b): Graphs displaying the dynamic range C⁺/C⁻=Ω and relative standard deviation σ provided by the inventive quantitation assay and the relation between the common ratio x of geometric sequence and the number N′ of copies of compartments in accordance with the present invention

FIGS. 3a), 3b), 3c), 3d): Inventive concept of active stripe, microstate and the precision of estimates derived from the assays in accordance with the present invention

FIGS. 4a), 4b), 4c): Graphs displaying the standard deviation of the estimate of concentration of particles E(C), for two different approaches (summation and microstate) of analyzing the signals from the compartments in accordance with the inventive method.

FIGS. 5a) and 5b): Graphs displaying the probability distributions p(μ|C) for the first 10 (FIG. 5a) and first 90 (FIG. 5b) most frequently occurring microstates in two different assays designed in accordance with the present invention

FIG. 6: Graph displaying the calibration correction function ƒ_{corr}=C/E(C) of initial concentration C=M/V of particles for the inventive quantitation assay

FIGS. 7a), 7b) and 7c): Graph displaying the sum of values K=Σwᵢ·kᵢ, with weights wᵢ=1/dᵢ as a function of the number of particles M (FIG. 7a); Graph displaying the value of the estimate E(C) of initial concentration of particles as a function of K (FIG. 7b); Graph displaying the relative standard deviation σ(C) of the estimate E(C) as a function of the logarithm of initial concentration C=M/V of particles for the inventive quantitation assay (FIG. 7c)

FIGS. 8a) and 8b): Graphs displaying the results of 100 Monte Carlo (MC) simulations for inventive assays and 7 or 8 experiments as experimental and numerical verification of the performance of the inventive method.

FIGS. 9a) and 9b): Graphs showing relative standard deviation, dynamic range and the estimate of concentration as a function of signal from assays comprising identical compartments and analyzed for the concentration of finite number of particles in the sample (analysis with non-independent random variables) and for the concentration of particles in the sample being scaled concentration of the reservoir (identical and independent random variables)

### DETAILED DESCRIPTION OF THE INVENTION

The inventors have surprisingly identified that by use of the embodiments of the present invention (parts A, B, C, D, E, and/or F, wherein the preferred inventive embodiments of part A, B, C, D, E and F can independently from each other be combined), in particular the inventive method, the inventive apparatus, the inventive sample holder and/or the inventive kit one or more needs underlying the present invention can be met (see in particular FIGS. 1a), 1b) and 1c) and respective parts in detailed figure description).

Generally, the invention relies on the unexpected discovery that it is possible to preferably and significantly reduce the number of partitions required to perform an assay in a defined concentration range with specified precision and specified accuracy, provided that the estimated values of the number of target particles in individual partitions are different. Formally, the estimated number of particles in the i-th compartment is mᵢ=C·dᵢ·vᵢ, where vᵢ means the volume of the i-th compartment, dᵢ means the dilution factor of the i-th compartment and C is the unknown concentration of in the sample. The essence of the present invention is that imposing the requirement that the values mᵢ are not equal to each other, preferably that they are essentially different, and most preferably that they span approximately the same range of values as the required range of concentrations, for which the assay should provide an accurate estimate of the initial concentration of target particles, allows one to preferably reduce the number of partitions required to perform a quantitation assay of the initial number of particles in a defined range of concentrations and with a specified precision.

The inventors of the present invention have surprisingly discovered that by partitioning the sample in accordance with the inventively determined number N of compartments and the determined modulation factor zᵢ the span of the assay dynamic range C⁺/C⁻ and the maximum value of the relative standard deviation (σ_{Max}) of the estimate of the concentration E(C) of particles can independently be predetermined, or in other words controlled or tuned (see in particular FIG. 1a) and respective part in the detailed figure description).

The inventive determination of estimate of concentration E(C) of particles generally comprises determination of estimate of concentration E(Cₛₐₘₚₗₑ) of particles in the sample as well as the determination of estimate of concentration E(Cᵣₑₛₑᵣᵥₒᵢᵣ) of particles in the reservoir or the determination of estimate of concentration E(C_{specimen}) of particles in the specimen, which is in detail explained in the following. The estimate of concentration E(C) is a function of the estimated number E(M) of particles in the respective sources, e.g., sample volume, reservoir volume or specimen volume. Accordingly, in case estimate of concentration E(C) of particles is used with respect to the present invention the term generally comprises the estimate of concentration E(Cₛₐₘₚₗₑ) of particles in the sample, the estimate of concentration E(Cᵣₑₛₑᵣᵥₒᵢᵣ) of particles in the reservoir and the estimate of concentration E(C_{specimen}), unless stated otherwise.

Thus, in a preferred embodiment the present invention relates to the determination of the concentration of particles in the sample E(Cₛₐₘₚₗₑ)=E(M)/Vₛₐₘₚₗₑ, wherein E(M) is the estimated number of particles in a sample of volume Vₛₐₘₚₗₑ. In the procedure the volume of the sample is partitioned and mixed with appropriate volumes of reagents, to allow for amplification of the presence of particles in the compartments to a measurable signal and to obtain the desired volumes vᵢ and dilution factors dᵢ=(mᵢ/vᵢ)/(M/Vₛₐₘₚₗₑ), where mᵢ is the estimated number of particles in i-th compartment. The quotients (M/Vₛₐₘₚₗₑ) and (mᵢ/vᵢ) can be coded as concentrations of particles in the sample (Cₛₐₘₚₗₑ) and of particles in the i-th compartment (Cₛₐₘₚₗₑ), yet as there is a finite number of particles in the sample, and placement of a particle in one compartment affects the probability of finding it in another compartment it has to be understood that these are not true concentrations as they only represent the estimated number of molecules scaled by the volume of either sample or compartment. As will be discussed below, the appropriate—and known in the prior art—approach to the analysis of the signals from compartments is based on the dependant random variables of placement of particles in the compartments. Such analysis yields the estimated number E(M) of particles in the sample, that can be represented as the estimated concentration E(Cₛₐₘₚₗₑ) of particles in the sample.

In an alternative preferred embodiment it is preferred that the sample volume Vₛₐₘₚₗₑ containing the particles of interest is prepared (e.g. by isolation or purification of particles) from a volume V_{specimen} of a specimen. In such a case, the estimate E(M) of the number of particles in the sample is the same as the estimate of the number of particles in the specimen. These can be represented either by the estimated concentration of particles in the sample E(Cₛₐₘₚₗₑ)=E(M)/Vₛₐₘₚₗₑ or by estimated concentration of particles in the specimen E(C_{specimen})=E(Cₛₐₘₚₗₑ)(Vₛₐₘₚₗₑ/V_{specimen})=E(M)/V_{specimen}.

In an alternative preferred embodiment of the present invention the volume V_{specimen} of the specimen may be taken from a much larger volume of a reservoir (e.g. an organism, or environment). It may be then of interest, and is possible with the use of the present invention, to estimate the concentration E(Cᵣₑₛₑᵣᵥₒᵢᵣ) of particles in the reservoir. In such a case the placement of particles in the compartments formed by partitioning and optionally also diluting the sample is treated as a set of independent random variables. The probability of finding a particle in any given compartment is, within this approach, only a function of the volume of the compartment, the dilution ratio of the sample in the compartment and of the concentration Cₛₐₘₚₗₑ of particles in the sample which is in turn equal to the concentration of particles in the reservoir, scaled by the appropriate quotients of volumes of sample and of specimen. As a result of calculation based on the signals from the compartments the invention allows to retrieve the estimate of concentration of particles in the sample E(Cₛₐₘₚₗₑ). The estimate of the concentration of particles in the reservoir is the same as the estimate of concentration of particles in the specimen: E(Cᵣₑₛₑᵣᵥₒᵢᵣ)=E(C_{specimen})=E(Cₛₐₘₚₗₑ)(Vₛₐₘₚₗₑ/V_{specimen}).

Alternatively, the estimate of the concentration E(Cᵣₑₛₑᵣᵥₒᵢᵣ) of the particles in the reservoir can also be preferably determined by transforming the estimate E(M) of the number of particles in the sample obtained from a calculation based on a distribution of dependent variables. In most general terms, the probability distribution of concentration in the reservoir ρ(Cᵣₑₛₑᵣᵥₒᵢᵣ) is equal to an integral transform of the distribution of probability of the number of particles in the sample ρ(M/Vₛₐₘₚₗₑ). In a simplified protocol, the estimate of E(Cᵣₑₛₑᵣᵥₒᵢᵣ) can preferably be determined by multiplying E(M)/Vₛₐₘₚₗₑ by a correction function ƒ_{corr}(E(M)) and by scaling it by the quotient Vₛₐₘₚₗₑ/V_{specimen}.

Thus, the inventive method of determining the estimate of concentration E(C) of particles is also advantageous over the prior art, as it provides solutions for determining the estimate of concentration of particles in the sample E(Cₛₐₘₚₗₑ) being an expression of the estimate of a finite number of particles distributed non-independently between compartments, divided by the volume of the sample, or for determining the estimate E(Cᵣₑₛₑᵣᵥₒᵢᵣ) of concentration of particles in the reservoir from which a specimen was taken, from which the sample was prepared, with E(Cᵣₑₛₑᵣᵥₒᵢᵣ) calculated from an estimate of concentration of particles on the basis of their independent placing in compartments.

### Embodiments of the Invention Part A

The present invention is particularly preferred, as it teaches how to modify the volume and/or dilution factor of the sample in the i-th compartment and, thus, allowing to independently tune the dynamic range and the precision of a quantification assay.

Furthermore, the inventive method teaches how to determine the number (N) of separate compartments and the modulation factor (zᵢ) for a predetermined upper limit (C⁺) and lower limit (C⁻) of the interval of concentration (C) to be estimated by the method as well as for a predetermined maximum allowable relative standard deviation (σ_{MAX}) of the estimate of concentration E(C) of particles, so that

a) the total number (N) of compartments comprising the predetermined sample volume can be adjusted, preferably reduced and, e.g., a wide dynamic range with good precision and small N (e.g. Ω=10⁹ with a <50% can be realized with N=60), ii) a wide dynamic range with high precision and small N (e.g. Ω=10⁹, σ<10%, N=1615) or iii) a narrow dynamic range with high precision and again small N (e.g. Ω=10³ with the benefit of obtaining σ<30% with N=80 and σ<10% with N=631) can be realized and/or

b) the total volume of a mixture comprising or consisting of sample, one or more reagents suitable for amplifying at least part of the particles to a measurable signal and optionally one or more diluents in all of the (N) compartments can be adjusted, preferably reduced and/or

c) the volume, preferably the minimum or maximum volume of the mixture comprising or consisting of sample, one or more reagents suitable for amplifying at least part of the particles to a measurable signal and optionally one or more diluents in each of the (N) compartments can be predetermined.

Furthermore the inventive method is preferably easier with respect to carrying out the mathematical analysis and may preferably provide feedback regarding the precision of the estimate of concentration E(C) prior to carrying out the inventive procedural steps of amplification, measurement and assignment as well as determination of concentration, which will be in detail described with respect to the inventive concept of active stripe and microstate μ further down in the following description.

With respect to step a) of the inventive method the number (N) of compartments represents an integer 0 to N−1, wherein the integer is generally predetermined in accordance with the given function, wherein the integer is larger than the real results of the function, preferably wherein the integer is the smallest integer larger than the real result of the function.

In step b) of the inventive method the value of the modulation factor (zᵢ) is preferably determined based on a well defined power sequence, an exponential sequence, preferably a geometrical sequence; a polynomial sequence or based on a distribution in the set of compartments, preferably predetermined by Gaussian distribution or a combination thereof. More preferably the value of the modulation factor (zᵢ) is determined based on the exponential sequence, such as a geometric sequence (volumes and or dilutions of subsequent compartments represent terms of a geometric series (vᵢdᵢ·eⁱ), as thereby a uniform fractional precision regarding the estimated concentration E(C) of particles over the dynamic range C⁺/C⁻ can be achieved. Further preferred embodiments are also disclosed in the following description. More generally, the set of values of the products vᵢdᵢ can be determined by any function that is non-uniform over the range of variation of the index i and may be a function of the dynamic range of the assay, of the precision of the assay and of other important parameters of the assays and its technical realization.

The inventive method is generally suitable to determine the concentration of any particle which optionally after suitable amplification exhibits a suitable measurable signal in the compartment. In a preferred embodiment the inventive method can be used to determine suitable particles preferably selected from the group consisting of a virus, a bacterium, a nucleic acid (NA), preferably a deoxyribonucleic acid (DNA) or a ribonucleic acid (RNA), a peptide, a protein, or another particle, or a nanoparticle or a colloidal particle or a combination thereof.

The inventive method is furthermore generally applicable to all quantitative determination methods of the estimate of a concentration of particles E(C) according to the prior art (e.g. analytic and/or diagnostic quantitation assays), wherein at least part of the particles that are present in any of the (N) compartments provide a measurable signal or are amplified to provide a measurable signal by common procedures, and the estimated concentration of particles E(C) is a function of measured signals determined by common statistical models.

Preferably the inventive method is applicable to assays amplifying the presence of an inventively suitable particle to a measurable signal, preferably wherein the particles are amplified by means of polymerase chain reaction (PCR), preferably comprising cyclic temperature variation; loop-mediated isothermal amplification (LAMP); rolling circle amplification (RCA); cascade rolling circle amplification (Cascade RCA); helicase-dependent amplification; nucleic acid sequence based amplification (NASBA); nicking enzyme amplification reaction (NEAR); single-molecule enzyme-linked immunoabsorbent assay (digital ELISA); or any other procedure for amplification of the presence of a particle to a measurable signal, or a combination thereof.

With respect to the inventive determination of the estimate concentration E(C) of particles any common statistical method for determination of estimate concentration E(C) of particles in quantitative assays can be used. Preferred embodiments of the present invention are disclosed further down in the following description.

In accordance with the present invention the partitioning of the predetermined sample volume in step b) into N compartments can be conducted by any suitable common method. In a preferred method, the sample is partitioned according to the determined number N of compartments and according to the determined modulation factor zᵢ by suitable means of pipetting the sample volume; by suitable means of droplet generation by microfluidic systems, preferably active and/or passive droplet generation; by suitable means of digital microfluidic techniques (also referred to as “electro-wetting on dielectric” EWOD), or by any other suitable method for obtaining the partitioned set of compartments (such as, e.g. disclosed in WO 2012/109600 A2, which disclosure in context with partitioning is incorporated herein in its entirety).

With respect to the pipetting technique a common serial dilution through repetitive mixing, splitting and adding diluents (suitable buffers) generally enables the inventive partitioning of the predetermined sample volume according to the determined number N of compartments and according to the determined modulation factor zᵢ. As an example, the first compartment of the series may comprise a certain volume v₀ of the predetermined sample volume with a concentration C₀, then the second compartment of the series comprises a fraction x of the predetermined sample volume which is then diluted by adding suitable diluents to reach the volume v₀, so that the second compartment comprises C₁=C₀x¹. Repeating this procedure yields a geometric progression of concentrations Cᵢ=C₀xⁱ. A suitable apparatus for conducting such a pipetting procedure is for example a hand pipette, or any of the commonly known robotic pipetting stations, or apparatus dedicated to pipetting ultra small volumes, as for example the Mosquito apparatus marketed by TTP Labtech.

In general the aforementioned pipetting method can also be used to prepare a set of compartments presenting a geometric progression of the estimated number of particles: (dᵢvᵢ)/(d₀v₀)=zᵢ=xⁱ by modulating either the concentration, or the volume of each compartment, or both, in any sequence or combination.

With respect to the microfluidic system technique all suitable common techniques can be applied to the present invention, in particular, common active droplet microfluidic systems and passive microfluidic systems, which enable the inventive partitioning of the predetermined sample volume in accordance with the determined number N of compartments and according to the determined modulation factor zᵢ.

With respect to the active droplet microfluidic system technique the present inventors have in particular developed a range of techniques for on-demand execution of operations on microdroplets in microfluidic chips. The operations include i) generation of a small droplet of precisely determined volume, ii) translating the droplet, iii) merging droplets, iv) splitting droplets. These operations allow executing practically any protocol of dilutions and inventive partitioning. The aforementioned active microfluidic technique has been disclosed in particular in the following patent applications PCT/PL2011/050002 “System and method for automated generation and handling of liquid mixtures”, filed 21 Jan. 2011 and the subsequent national applications; PL395776 “Sposób dzlelenia kropel na ż [symbol] danie w z [symbol] [symbol] czu mikroprzep [symbol] ywowym” filed 2011-07-27; PL395777 “Sposób dzlelenia kropel na ż [symbol] danie w z [symbol] [symbol] czu mikroprzep [symbol] ywowym” filed 2011-07-27; PL395778 “Sposób dzlelenia kropel na ż [symbol] danie w z [symbol] [symbol] czu mikroprzep [symbol] ywowym” filed 2011-07-27, wherein the content of each application in relation to the active microfluidic techniques is incorporated herein with respect to the present invention in their entirety.

With respect to the passive microfluidic systems (traps) the present inventors (for Scope Fluidics) in particular have developed a system and method for execution of precise operations on droplets in a passive manner. The concept is based on the construction of well geometrically defined ‘traps’ in the microfluidic channels. The traps, depending on their exact geometry, can i) trap a droplet smaller than a given volume and hold it in place, ii) trap a droplet of precisely set volume and hold it in place, III) exchange a portion of liquid in the trapped droplet (i.e. accept a small additional volume and release the same volume of the original mixture), iv) trap, wait for arrival of a new droplet, then merge them and release, v) trap, wait for arrival of subsequent drop, then release just the first, while locking the second, etc. These functionalities allow building a lot of different liquid handling protocols, which can be used in accordance with the present invention. The aforementioned passive microfluidic technique (so called “TRAPS” system and method) has been disclosed in particular in the following patent application [PL-398979 “Urz [symbol] dzenie mikroprzep [symbol] ywowe i uk [symbol] ad mikroprzep [symbol] ywowy obejmuj [symbol] cy jedno lub wi [symbol] cej urz [symbol] dzerń mikroprzep [symbol] ywowych” filed 2012-04-25], wherein the content thereof in relation to the passive microfluidic technique is incorporated herein with respect to the present invention in its entirety.

Furthermore, the well established technological platform for manipulations of droplets on planar substrates called either ‘digital microfluidics’ or ‘electro-wetting on dielectric’ (EWOD) enables the inventive partitioning of the predetermined sample volume in accordance with the determined number N of compartments and according to the determined modulation factor zᵢ. The digital microfluidic technique/electro-wetting on dielectric (EWOD) technique allows to generate drops on demand, move them, merge, mix and split them.

The predetermined sample volume is in accordance with the present invention partitioned into N compartments, wherein any common sample holder suitable for holding the separate volumes so that the volumes can be further processed and/or analyzed in accordance with the inventive digital assays can be used.

In a preferred embodiment the predetermined sample volume is partitioned into an inventive sample holder according to the fourth aspect of the present invention. The sample holder of the present invention can comprise e.g. suitable test tubes, arrays of wells on a microarray, or a microfluidic chip, a microfluidic chip configured to generating droplets as well as other commercially available or otherwise generally known devices capable of holding discrete volumes suitable for carrying out the inventive method. In a furthermore preferred embodiment the predetermined sample volume is partitioned using the inventive kit in accordance with the fifth aspect of the present invention. All preferred embodiments of the fourth and fifth aspect of the present invention can independently from each other be combined with the present inventive method.

In a preferred embodiment of the present inventive method the modulation factor (zᵢ) is determinable, preferably is determined by the function zᵢ=(vᵢdᵢ)/(v₀d₀) or analogue thereof, wherein the analogue conveys information about pairwise differences in the estimated number of particles in compartments,

wherein (i), (vᵢ) and (dᵢ) is defined as set out hereinbefore and

wherein (v₀) represents the volume and (d₀) represents the dilution factor of the sample in a reference compartment, wherein the reference compartment is different to compartment (i), preferably wherein the reference compartment represents the first compartment in the series of (N) compartments. The term “first compartment in the series of (N) compartments” is defined with respect to the present invention as the compartment comprising part of the predetermined sample volume with the starting volume and starting dilution factor.

In a preferred embodiment of the inventive method in step b) 1%, preferably 5%, more preferably 25%, even more preferably 50%, even more preferably 75% and most preferably 100% of the (N) compartments differ from each other by the value of the modulation factor (zᵢ). The more of the (N) compartments differ from each other by the value of the modulation factor (zᵢ), the broader is the range of concentrations of particles in the sample that can be assayed.

However, the reduction to practice of partitioning the predetermined sample volume into the determined (N), wherein the (N) compartments comprise or consist of different sample volumes (vᵢ) and/or different dilution factors (dᵢ) of the sample and, thus, differ by the modulation factor (zᵢ) may be for some laboratories too challenging, as the differences caused by the determined modulation factor (zᵢ) may result in only minute changes with respect to volumes and/or dilutions of the different compartments when partitioning the sample. In this case the inventive method provides an alternative preferred embodiment to partition the sample into a number (N_{LIB}) of two or more separate sets of compartments (libraries), each library set is indexed with (j) and contains Nⱼ′>0 compartments, each compartment in the same library comprising or consisting of a part of the sample volume with the same value of a modulation factor (zⱼ), wherein zⱼ is a function of volumes (vⱼ) and dilution factors (dⱼ) of the sample in the library set (j), and wherein the N_{LIB} separate library sets j are distinguishable from each other by different values of the modulation factor (zⱼ), wherein j represents the index number of the number (N_{LIB}) library sets represented by the integers 0 to N_{LIB}−1. The library concept is further down described in detail with further preferred embodiments.

The inventive method is cumulatively or alternatively preferred, wherein in step b) the sample is partitioned into (N) compartments with such volumes (vᵢ) and dilution factors (dᵢ) as to fulfil the condition: vᵢdᵢ=v₀d₀zᵢ

wherein zᵢ>0, and at least for one value of (i) the quotient zᵢ₊₁/zᵢ is different from 1.

In accordance with a preferred method of the present invention in step b) the modulation factor zᵢ is based on en exponential series and the sample is partitioned into (N) compartments with such volumes (vᵢ) and/or dilutions (dᵢ) as to fulfil the condition:

$${v}_{i} = A \cdot {exp}^{( B \cdot \frac{i}{N} )}$$

and/or

$${d}_{i} = A \cdot {exp}^{( B \cdot \frac{i}{N} )} ,$$

wherein (A) and (B) represent independently of each other arbitrary real numbers and wherein preferably A=1/C⁺ and/or B=[1.95·ln {(C⁺/C⁻)/N}]^{0.856}. In this case it is even more preferred to divide the sample into (N) compartments

$$N = 2 \cdot {σ}_{MAX}^{- 1.9} \cdot {( \frac{{C}^{+}}{{C}^{-}} )}^{0.25} , preferably N = 2 \cdot {σ}_{MAX}^{- 1.94} \cdot {( \frac{{C}^{+}}{{C}^{-}} )}^{0.22} .$$

with (C⁺), (C⁻), and (σ_{MAX}) as hereinbefore with respect to the first aspect of the invention.

The case predetermined sample volume is in accordance step b) of the inventive method is partitioned with a geometric series, the inventive partitioning fulfil the following condition:

(vᵢ₊₁dᵢ₊₁)/(vᵢdᵢ)=zⱼ₊₁/zᵢ=x

wherein x>0 and x≠1, preferably wherein the value of (x) is represented by about 0.1, 0.5, 0.8, 0.9, 0.91, 0.92, 0.93, 0.94, 0.95, 0.96, 0.97, 0.98, 0.99, 1.01, 1.02, 1.03, 1.04, 1.05, 1.06, 1.07, 1.08, 1.09, 1.1, 1.2, 1.3, 1.4, 1.5, 2, or 10. In this preferred embodiment the modulation factors of two consecutive compartments (i+1) and (i) are compared and thereby representing a geometric series, which is preferred as already mentioned hereinbefore a uniform fractional precision over the dynamic range can be provided (see FIG. 2a) and respective part in the detailed figure description).

The inventors have surprisingly identified that the inventive method comprising a geometric series with quotient x=(vᵢ₊₁dᵢ₊₁)/(vᵢdᵢ) can preferably be gauged for the required precision of the estimate of concentration of particles E(C). For any particular value of the input concentration C* a compartment (i*) can be predetermined that is characterized by the product v_{i*}d_{i*}≈ ln(2)/C*. One can then consider the potential outcomes (presence or absence of particles) in compartments neighboring with i* in the geometric series. In particular one can consider the signals from ΔN/2 compartments on either “side”: (v_{i*+n}d_{i*+n})=(v₀d₀)x^{i*+n}, n∈(−ΔN/2, ΔN/2). As the probability of obtaining a signal depends on the volume v_{i*+n} and/or dilution factor d_{i*+n} of the compartment

$${i}^{*} + n : {p}_{{i}^{*} + n} = 1 - {e}^{- {Cv}_{0} {d}_{0} {x}^{{i}^{*} + n}} ,$$

inventors identified that compartments with much larger or much smaller volumes and/or dilutions than v_{i*}d_{i*} will not introduce significant information about the estimate of the concentration E(C)≈C* of particles (see FIG. 3a of respective part in the detailed figure description). Thus, the inventors found out that the relevant information for determining the concentration C≈C′ of particles should preferably be derived from a finite set of compartments, that is in accordance with the present invention be called “active stripe” and comprises or consists of ΔN compartments.

The inventors have unexpectedly found, that in order for the assay to assess any concentration within a required dynamic range C∈(C⁻, C⁺) it is possible to prepare I) a main set of compartments presenting a geometric series of the factors vᵢdᵢ spanning values from ln(2)/C⁻ to ln(2)/C⁺ and ii) supplement this set with margins of ΔN/2 compartments presenting the same geometric progression, and placed on each end of the aforementioned main set.

According to the aforementioned preferred embodiment the inventive method is additionally optimized, as the inventors furthermore found out that the entirety of information that is conveyed by any outcome of the experiment is contained in the particular arrangement—in the context of the present invention called “microstate (μ)”—of the signals, which lead to an assignment of a first value (kᵢ) to the compartments (i) that comprise or consists of a predetermined threshold number of particles or more (positive value). In other words, the detailed distribution of signals accounting for the state of each compartment is referred to as a microstate (μ) in the context of the present invention.

Both the number and the localization of the respective compartments (i) assigned with the first value (kᵢ) within the active stripe are stochastic variables. Repetitive experiments with the same initial concentration of the particles will yield different answers. Each such outcome has a different probability of happening from different input concentrations of the particle. Thus, the observation of each particular microstate (μ) carries a different expectation on the estimated concentration E(C) of particles (see FIGS. 3a, 3b, 3c, 3d of respective part in the detailed figure description).

Using geometric series the precision of the estimate concentration E(C) of particles generally depends on the common factor of the geometric series and on the number of compartments. Two important observations can then be made. First, in accordance with the values of the standard deviations most of the outcomes of the estimated concentration E(C) fall very close to the input concentration (C*) (see FIG. 3d of respective part in the detailed figure description). Second the standard deviations offered by the analysis of the microstates are smaller than those obtained from the analysis of the sum K of positive values (see FIG. 4a), 4b) and 4c)) of respective part in the detailed figure description). Further the standard deviations associated with the microstates have a well defined envelope from above. This limit is given by the probability of the standard deviation ρ(C|μ) calculated for the most probable microstate using the Bayes theory transforming ρ(μ|C). This microstate has all the compartments for which vᵢdᵢ>v_{i*}d_{i*} yielding the first value (kᵢ) and all the others including v_{i*}d_{i*} having assigned a second value (kᵢ), wherein the second value (kᵢ) is assigned, in case the compartment (kᵢ) comprises or consists of less than the threshold number of particles indicating the first value (negative value) (see FIGS. 5a) and 5b) and respective part in the detailed figure description).

An inventive method containing a long sequence of compartments will yield in the vast majority of the uses of the assay the precision of the estimate of the concentration either same, or more likely higher, or most likely significantly higher than the precision as the estimate calculated on the basis of the most probable inventive microstate. In addition the inventors surprisingly found out, that, especially (i.e. most likely), for concentrations dose to the limits of the dynamic range of the method (i.e. for C≈C⁻ or C≈C⁺)—the inventive method may return with a small probability an unlikely set of signals/values that yield a low precision of the estimate and, thus, will inform the user (by providing the value of standard deviation higher than requested) that the unfortunate event has happened and that the experiment should be repeated. Although the digital assays of the prior art also allow small probability of unlikely events that provide misinformed estimates of the concentration, only the aforementioned preferred inventive feature using the microstate approach can provide the feedback to the user on such an unfortunate unlikely event occurring.

Increasing the number ΔN of partitions in the active stripe according to the present invention obviously improves the estimate of E(C) yet only to a certain limit, because the much larger and much smaller compartments than v_{i*}d_{i*} progressively carry less and less information. Indeed, for any value of x the standard deviation of the estimate concentration falls with increasing ΔN only to a limit σₘₐₓ(x)≈1.2739(1−x)^{1,9895}. The corresponding value of ΔN that yields compromise between high precision and small number of compartments can preferably be determined by the function ΔN(x)=4.5637(1−x)^{-0.798}.

One way of carrying out the aforementioned preferred inventive method is that the inventive method with the geometric series with quotient x=(vᵢ₊₁dᵢ₊₁)/(vᵢdᵢ) is determinable, preferably determined by the function:

$$x = 1 - {( \frac{{σ}_{max}}{0.8955} )}^{1 / 0.513} ,$$

the number (N) of compartments is preferably set to an integer not smaller than the value determinable by the function:

$$N = Δ N + {log}_{x} ( \frac{{C}^{-}}{{C}^{+}} ) ,$$

wherein (ΔN) is preferably an integer not smaller than the value determinable, preferably determined by the function:

ΔN=4.5637(1−x)^{-0.798}

and wherein the value for d₀v₀ is determinable, preferably determined by the function

$${d}_{o} {v}_{o} = ln ( 2 ) \cdot {x}^{- Δ N / 2} ( \frac{1}{{C}^{-}} )$$

with (C⁺), (C⁻), (σ_{MAX}), (dₒ) and (vₒ) as defined hereinbefore with respect of the first aspect of the invention.

The partitioning of the sample according to the aforementioned preferred inventive method can be designed in the following steps: (i) for given for a given (C⁺), (C⁻) and (σ_{MAX}) the values for N, ΔN and x are determined, ii) using x and ΔN the volume vₒ and dilution factor dₒ of the first compartment in the sequence is determined and (iii) the sequence of N compartments with (vᵢdᵢ)=(v₀d₀)xⁱ wherein (i) represents an index number of the N compartments with integers from 0 to N−1.

The simple equations above of the inventive method create a powerful analytical tool. First, the dynamic range

$$( \frac{{C}^{+}}{{C}^{-}} = Ω )$$

can be tuned completely independently of the precision. Second, for a given required minimum precision and dynamic range, the inventive method requires even 10² to 10⁴ times less compartments than the standard digital assays using equal volumes in the compartments.

For example, with the classic assay, to address dynamic ranges of Ω=10⁴ or Ω=10⁷ one needs, according to the state of knowledge in the field N≧2·10³ or N≧2·10⁶ test volumes respectively. If a precision of the estimate of E(σ)<50% is satisfactory, the same Ωs can be assessed by the inventive method comprising only as few as 35 or 47 compartments. If a more precise experiment is needed (i.e. σ<25% or σ<10%), only 140 and 795, or 192 and 1120 test-volumes respectively are needed with respect to the inventive method. These numbers are orders of magnitude smaller than in the case of the classical assay qualitatively changing the technical requirements to run them.

The operation of the algorithms was verified both numerically and experimentally on assays, with varied dynamic ranges and precision: (i) Ω=10³, σ≦80%, N=10, x=0.50, and (ii) Ω=10², σ≦60%, N=10, x=0.60 (see Examples as well as FIGS. 8a) and FIG. 8b) and respective parts in the detailed figure description).

The inventive method furthermore proves to be superior over the multivolume digital assay approach of the prior art [Shen, F.; Sun, B.; Kreutz, J. E.; Davydova, E. K.; Du, W.; Reddy P. L.; Joseph, L. J.; Ismagilov, R. F., “Multiplexed Quantification of Nucleic Acids with Large Dynamic Range Using Multivolume Digital RT-PCR on a Rotational SlipChip Tested with HIV and Hepatitis C Viral Load”, J. Am. Chem. Soc., Article ASAP (X 2011)], which already increased the span of the dynamic range in comparison to the standard digital assays using equal volumes. The multivolume method of Ismagilov shows a 3-fold resolution (corresponding to sigma (standard deviation of the estimate) of 30%), the following dynamic range: (a)—about 10⁴ (between 5.2·10² and 4.0·10⁶) while using 640 compartments (4 families, design 1) and (b)—ca 10⁵ (between 1.7·10² and 2.0·10⁷) while using 880 compartments (6 families, design 2B).

Comparing the method of Ismagilov with the inventive method, the inventive method obtains the same dynamic range and precision with: (a)—N=98 compartments (x=0.881373264) and (b)—N=117 compartments (x=0.881373264)

From a different side, if allowed to use 640 compartments, the inventive method can yield the following combinations of dynamic range and precision: a dynamic range of 2·10³ with σ<10%; a dynamic range of 5·10⁷ with σ<15%; and a dynamic range >10¹⁰ with σ<30%.

If allowed to use 880 compartments, the inventive method can yield a dynamic range of 3·104 with σ<1010; a dynamic range of 1010 with σ<15%; and a dynamic range >>1010 with σ<30%. Thus, the above comparison shows that quantitatively the inventive method can i) reduce the number of compartments from 640 to 98, and from 880 to 117, ii) for the same number of compartments can increase the dynamic range by a factor of million or better, and iii) provides the option to freely tune the dynamic range and precision.

In diagnostics the often considered parameter of the assay is its resolution in statistically significant determination that two samples have different concentrations. The resolution of the inventive method is closely approximated by the standard multiplication of the standard deviations, i.e. 70, 90, 95% confidence of distinguishing two samples is realized for samples differing in concentration by a factor of rσ with r=1, 2 or 3. Thus, if one knows the required resolution of the assay R=C₁/C₂ and the required confidence, then the standard deviation to be inserted into the equations designing the assays is σ=(R−1)/r.

One additional benefit of the inventive method is that it can yield the complete information from any single stochastic realization of the experiment. In other words, the preferred scalings that are listed above provide the likely highest standard deviation (i.e. the minimum precision guaranteed by the assay): the declared standard deviation σ of the estimate E(C) is the likely highest value σᵤ_{ᵢ} for all the microstates observed in the assay for C's within a range C (C⁻, C⁺). It might, however, happen that the method returns a lucky answer (microstate) μᵢ that yields a smaller standard deviation σ_{μ}_{ᵢ} of the estimation E_{μ}_{ᵢ}(C) and therefore yielding higher precision, wherein here i indexes the microstates i=0 to 2N−1. With the increase of x the distribution of a becomes narrower and closer to the value of maximum standard deviation. Interestingly, the expected value of the standard deviation σ_{expected}(x) can be preferably represented as a polynomial function of x. This could be used as a basis for designing the assay in place of the maximum standard deviation σₘₐₓ(x).

Using the inventive concept it is further preferred to construct assays that provide different required precision in different ranges of concentration. This could be useful in diagnostics, where e.g. at low and high concentrations precision can be sacrificed for the dynamic range, while in the intermediate range of concentration the exact estimate is clinically informative.

Accordingly another preferred inventive method relates to dividing the interval (C⁻, C⁺) into q subintervals (Cₙ⁻, Cₙ⁺), preferably disjoint ones, in each subinterval the set of values dᵢvᵢ is a geometric series with quotient xₙ, whereas:

$$\begin{matrix}For {σ}_{{n}_{max}} < {σ}_{n - {1}_{max}} \\ {x}_{n} = 1 - {( \frac{{σ}_{{n}_{max}}}{0.8955} )}^{1 / 0.513} \\ Δ {N}_{n} = 4.5637 {( 1 - {x}_{n} )}^{- 0.798} \\ {N}_{n} = Δ {N}_{n} + {log}_{{x}_{n}} ( \frac{{C}_{n}^{-}}{{C}_{n}^{+}} ) \\ {d}_{{n}_{0}} {v}_{{n}_{0}} = ln 2 \cdot {x}_{n}^{- Δ {N}_{n} / 2} ( 1 / {C}_{n}^{-} ) & 1 ) \\ For {σ}_{{n}_{max}} > {σ}_{n - {1}_{max}} \\ {x}_{n} = 1 - {( \frac{{σ}_{{n}_{max}}}{0.8955} )}^{1 / 0.513} \\ Δ {N}_{n} = 4.5637 {( 1 - {x}_{n} )}^{- 0.798} \\ {N}_{n} = 0.5 Δ {N}_{n} + 0.5 Δ {N}_{n - 1} + {log}_{{x}_{n}} ( \frac{{C}_{n}^{-}}{{C}_{n}^{+}} ) \\ {d}_{{n}_{0}} {v}_{{n}_{0}} = ln 2 \cdot {x}_{n - 1}^{- Δ {N}_{n - 1} / 2} ( 1 / {C}_{n}^{-} ) & 2 )\end{matrix}$$

2. where: C⁻ means the lower limit of the interval for the determination of the unknown concentration C, C⁺ means the upper limit of the interval for the determination of the unknown concentration C, Cₙ⁻ means the lower limit of the subinterval with the number n, Cₙ⁺ means the upper limit of the subinterval with the number n, σₙ_{ₘₐₓ} means the maximum permitted standard deviation of the estimate E(C) of the unknown concentration C of particles in the sample in the subinterval (Cₙ⁻ Cₙ⁺), n is the subinterval number, running over integers from 1 to q, and i is the number of compartment in n-th interval, running over integers from 0 to Nₙ−1.

According to a further cumulatively or alternatively preferred inventive method, the inventive method comprises or consists of the following steps:

c) optionally amplifying the particles of the compartments with one or more suitable reagents and optionally one or more diluents for obtaining a measurable signal indicating the presence of a predetermined threshold number of particles, preferably one, two, three or more particles in a compartment,

d) measuring the signals in each of the (N) compartments and assigning to at least part, preferably all compartments a value (kᵢ), wherein (i) represents the index number of the compartments represented by integers 0 to N−1 and compartment (i) is assigned a first value (kᵢ), if the compartment (i) comprises or consists of the predetermined threshold number of particles or more, and compartment (i) is assigned a second value (kᵢ), if the compartment (kᵢ) comprises or consists of less than the threshold number of particles indicating the first value and

e) determining the estimated concentration of particles E(C), wherein the estimated concentration of particles E(C) is determinable by a function of

i. a sum K of first and/or second values (kᵢ), wherein the function preferably is corrected using a calibration correction function, and/or

ii. a sum K of first and/or second weighted values (wᵢkᵢ), wherein at least part of the values (kᵢ), preferably each value (kᵢ) is modulated with a weight value (wᵢ), wherein (i) represents the index number of the compartments represented by the integers 0 to N−1, and wherein the weight value (wᵢ) preferably is inversely proportional to the degree of volume and/or dilution of the number (i) of the compartments, and wherein the function is preferably corrected using a calibration correction function, and/or

iii. a number, vector, matrix, tensor of any order or any other unambiguous representation of a microstate μ, wherein the number, vector, matrix, tensor of any order or any other representation comprises or consists of information reflecting at least part of the values (kᵢ) measured in step e), preferably comprises or consists of a vector k≡(kᵢ), representing the microstate μ, wherein the vector (k) comprises or consists of at least part, preferably all of the values (kᵢ) measured in step e).

In case the particles to be measured do not provide as such a measurable signal, it is according to inventive method step c) preferred to amplify the particles so that at least part of the particles, preferably all of the particles provide a measurable signal. A suitable measurable signal is any signal which can be detected visually and/or by suitable means. In a preferred method the particles are labeled with a suitable component, e.g. a reporter molecule, which bind, form complexes or interact with the particles in another way so that they excite light of specific wavelength and/or electricity upon suitable excitation, preferably they exhibits fluorescence (up and downconverting), exhibit light in the infrared (IR) range (near and/or far infrared wavelength, NIR/FIR), or exhibit electricity. Reporter molecules in particular suitable for use in any of the hereinafter mentioned amplification methods are commonly known. In a preferred method two reporter molecules can be used, which compete for a single binding site of the particle to be determined and, thus, furthermore extend the dynamic range of the inventive method. An example of suitable reporter molecules is given in WO 2012/049316 A1, wherein the different reporter molecules (markers) are used to interact (directly or indirectly) with the particles of the sample, wherein the reporter molecules are preferably nucleic acid molecules, e.g. oligonucleotides. Such reporter molecules are preferably used in proximity probe-based detection assays and the disclosure of WO 2012/049316 A1 concerning the suitable reporter molecules (markers) is incorporated herein in its entirety.

The inventive method is according to step c) applicable to any amplification method for quantitatively determining the presence of the particles. Preferably the inventive method is applicable to methods amplifying the presence of a particle to a measurable signal, preferably wherein the particles are amplified by means of polymerase chain reaction (PCR), preferably by cyclic temperature variation, loop-mediated isothermal amplification (LAMP), rolling circle amplification (RCA), cascade rolling circle amplification (Cascade RCA), helicase-dependent amplification, nucleic acid sequence based amplification (NASBA), nicking enzyme amplification reaction (NEAR), single-molecule enzyme-linked immunoabsorbent assay (digital ELISA), or any other procedure for amplification of the presence of a particle to a measurable signal, or a combination thereof. The aforementioned amplification methods are known in the prior art and a person skilled in the art will readily know which suitable one or more reagents and optionally one or more diluents can be used.

With respect to the inventive method step d) the mixture in every compartment containing the particles and optionally one or more reagents and optionally one or more diluents is generally suitably excited so that a compartment comprising at least a particle exhibits a signal indicating the presence of the particle, e.g. by fluorescence and/or phosphorescence and/or electricity intensity. The value of the signal in at least a part, preferably all compartments is measured with suitable means. Subsequently the value of signal is respectively transformed by suitable means, such as detectors suitable for measuring fluorescence, phosphorescence intensity and transforming the signal into the first or second value (kᵢ) respectively assigned at least part, preferably all of the compartments (i). Preferably, the threshold number of particles is 1, 2, 3, 4, 5, 6, 7 or more particles, more preferably 1 particle in a compartment. The first and second valued (kᵢ) can be any suitable values, preferably values wherein the first value (kᵢ) represents a positive value indicating the presence of the threshold number of particles in the compartment (i) and the second value (kᵢ) represents a negative value indicating that the threshold number of particles in the compartment is not present in the compartment (i). Preferably the first and second values (kᵢ) comprise binary values, wherein the first value (kᵢ) is preferably represented by “1” or any other integer, real number or sign and the second value (kᵢ) is preferably represented by “0” or any other integer, real number or sign different from the integer representing the first value (kᵢ).

According to step e) of the inventive method preferred methods of determining the estimated concentration of particles E(C) are disclosed.

According to a first alternative i) of the inventive method the sum K of first and/or second values (kᵢ), preferably the set of {kᵢ}, N and {vᵢdᵢ} or P(vᵢdᵢ) values, wherein P(vᵢdᵢ) is preferably a function of the volume and/or dilution, is transformed by known statistical algorithms, preferably by use of the Bayes theorem into the estimate of concentration.

Preferably the aforementioned function is corrected using a calibration correction function. The suitable calibration correction function may be determined experimentally, using standard samples with concentrations of target particles within the dynamic range of the test. The calibration correction can also be computed numerically based on the dependence of the estimate E(C) of the concentration of particles in the sample and the actual number of particles M randomly distributed in compartments divided by the volume of the sample: C=M/Vₛₐₘₚₗₑ: f_{corr}(C)=C/E(C). Having computed the calibration correction f_{corr}(C), the corrected estimate of the number of particles is determinable, preferably determined with the formula E_{corr}(C)=E(C)·f_{corr}(C). For instance, for a distribution of 474 partitions with volumes given by the formula vᵢ=e^{0.0115·i}, for index i running over the values from 0 to 473, the correction is f_{corr}(C)=(−1.48·10⁻⁵·C+1.09)⁻¹ (see FIG. 6 and respective part in the detailed figure description).

To overcome the aforementioned drawbacks in the analysis of multi-volume assays the inventors have surprisingly identified to inventively determine the estimate concentration E(C) of particles by use of a simple sum K of first and/or second weighted values (wᵢkᵢ) applying common statistical methods, wherein at least part of the values (kᵢ), preferably each value (kᵢ) is modulated with a weight value (wᵢ), wherein the weight value (wᵢ) preferably a function on dilution factors and/or volumes of compartments (wᵢ=ƒ(dᵢ, vᵢ)) and more preferably is inversely proportional to the degree of dilution factors and/or volumes of the number (i) of the compartments (see FIG. 7a), 7b) and 7c) of respective part in the detailed figure description). Preferably the determination of concentration C of particles is carried out using the set of preferably the set of {wᵢkᵢ}, N and {vᵢdᵢ} or P(vᵢdᵢ) values, wherein P(vᵢdᵢ) is preferably a non-increasing function of the volume and/or dilution, is transformed by known statistical algorithms, preferably by use of the Bayes theorem into the estimate of concentration. In case, the weight value (wᵢ) is dependent on the compartment volume and dilution a distribution of weights w(dᵢvᵢ) is employed, said distribution being selected from the group comprising:

a. w(dᵢvᵢ)≡1,

b. w(dᵢvᵢ)=(dᵢvᵢ)^{β}, where the exponent β represents an arbitrary real number,

c. w(dᵢvᵢ)=exp(βdᵢvᵢ), where the multiplier β is an arbitrary real number.

Preferably the aforementioned method according to alternative ii) is corrected using a calibration correction function as described hereinbefore with alternative i) (see FIG. 6 and respective part in the detailed figure description).

The aforementioned methods of determining the estimate of concentration E(C) of particles of alternative i) and ii) relate to determining the estimate of concentration E(Cₛₐₘₚₗₑₛ) of particles in the predetermined sample volume, as stochastic distribution of particles between compartments is a distribution of dependant variables. Hereinbefore it is described how to transform the functions to result at the estimate of concentration E(Cᵣₑₛₑᵣᵥₒᵢᵣ) of particles in the reservoir or the estimate of concentration E(C_{specimen}) of particles in the specimen.

The inventive summation procedures according to methods i) and ii) result, however, in a loss of some information, as the sum K of values, preferably binary values or the weighted sum K of values, preferably binary values does not contain unambiguous information on which compartments contained at least one target particle, and which did not.

In case of using the preferred inventive concept of the number, vector, matrix, tensor of any order or any other unambiguous representation of the microstate μ is preferably used to determine the estimate concentration E(C) of particles, wherein the number, vector, matrix, tensor of any order or any other representation comprises or consists of information reflecting at least part of the values (kᵢ) measured in step e), preferably comprises or consists of a vector k≡{kᵢ}, representing the microstate μ, wherein the vector (k) comprises or consists of at least part, preferably all of the values (kᵢ) measured in step e). The preferred embodiments of the first and/or second values of (kᵢ) as described hereinbefore with respect to step e) of the inventive method also apply with respect to the aforementioned preferred method. The surprising benefit of using the microstate μ approach is that the computational complexity of the procedure for computation of the estimate concentration E(C) of particles is reduced and the information on the probable concentration that caused the observed compartments contain at least a threshold number of particles is increased. The microstate μ approach provides preferably (i.e. most likely), for concentrations close to the limits of the dynamic range of the method (i.e. for C≈C⁻ or C≈C⁺) a feedback, and the inventive method will inform the user (by providing the value of standard deviation higher than requested) that the unfortunate event has happened and that the method should be repeated. As mentioned hereinbefore the inventive method may be used either to estimate the concentration of particles in the sample, or in a reservoir from which the specimen and sample were prepared.

Preferably, in step e) the calculations of the microstate p are performed with the use of a neural network mapping the vector k into the estimate E(C).

According to a preferred embodiment of the microstate p approach, in step e) of the inventive method the estimate concentration E(C) of particles is a function of the conditional probability p(μ|C) transformed by Bayes theorem into p(C|μ), preferably determined by the following operations are performed:

e1) calculation of conditional probability p(μ|C) from the formula:

p(μ|C)=Πᵢ₌₀^{N-1}[(1−e^{-Cv}^{₀}^{d}^{₀}^{z}^{ᵢ})^{k}^{ᵢ}(e^{-Cv}^{₀}^{d}^{₀}^{z}^{ᵢ})^{(1-k}^{ᵢ}⁾]

e2) calculation of conditional probability p(C|μ) from the formula:

p(C|μ)=p(μ|C)·[∫_{C}_{ₘᵢₙ}^{C}^{ₘₐₓ}dC·p(μ|C)]⁻¹

where:

Cₘᵢₙ=−C⁻ln(p_{TR})/ln(2), Cₘₐₓ=−C⁺ln(1−p_{TR})/ln(2), and: C⁻ means the lower limit of the interval for the determination of the unknown concentration C, C⁺ means the upper limit of the interval for the determination of the unknown concentration C, 0<p_{TR}<1 is a parameter specifying the assay precision, preferably Cₘᵢₙ=0 and Cₘₐₓ=∞;

in the case the series of values vᵢdᵢ is a geometric series with quotient x<1, Cₘᵢₙ and Cₘₐₓ are equal to: Cₘᵢₙ=C⁻x^{ΔN/2}, Cₘₐₓ=C⁺x^{-ΔN/2}, where ΔN=4.5637(1−x)^{-0.798}.

e3) determination of the concentration C as the estimate E(C), where:

E(C)=∫_{C}_{ₘᵢₙ}^{C}^{ₘₐₓ}dC·C·p(C|μ)

with standard deviation σ(C)=\sqrt{E(C²)−E²(C)}·[E(C)]⁻¹, where:

E(C²)=∫_{C}_{ₘᵢₙ}^{C}^{ₘₐₓ}dC·C²·p(C|μ)

As already described hereinbefore the inventive method also provides preferred solutions in case the determined number N of compartments and the determined modulation factor zᵢ leads to a partitioning of the predetermined sample volume, which cannot be handled in a respective laboratory in practice, e.g. as the suitable means of partitioning the sample are not present there. In this case the inventive method recommends to use the library approach, wherein in step b) the sample is partitioned into a number (N_{LIB}) of two or more separate sets of compartments (libraries), each library set is indexed with (j) and contains Nⱼ′>0 compartments, each compartment in the same library comprising or consisting of a part of the sample volume with the same value of a modulation factor (zⱼ), wherein zⱼ is a function of volumes (vⱼ) and dilution factors (dⱼ) of the sample in the library set (j), and wherein the N_{LIB} separate library sets j are distinguishable from each other by different values of the modulation factor (zⱼ), wherein j represents the index number of the number (N_{LIB}) library sets represented by the integers 0 to N_{LIB}−1.

With respect to the library approach the modulation factor (zⱼ) is preferably determined by the function of zⱼ=(vⱼdⱼ)/(v₀d₀) or an analogue thereof, wherein (vⱼ) represents the volume and (dⱼ) represents the dilution factor of the sample in the compartments of library set (j) and wherein (v₀) represents the volume and (d₀) represents the dilution factor of the sample in the compartments of a selected reference library set (j).

According to another preferred embodiment of the library approach in step b) of the inventive method at least part, preferably all of the number (N_{LIB}) library sets (j) comprise or consist of Nⱼ′=N′ compartments for each library set (j), and fulfil the condition: (vⱼ₊₁dⱼ₊₁)/(vⱼdⱼ)=zⱼ₊₁/zⱼ=x

wherein x>0 and x≈1. By using the geometric series with quotient x=(vⱼ₊₁dⱼ₊₁)/(vⱼdⱼ) the precision of the estimate of the concentration E(C) is optimized, preferably the precision is only worst by the factor 20% in comparison to the microstate μ approach described hereinbefore.

According to a further cumulatively or alternatively preferred embodiment of the inventive method the set of values vⱼdⱼ=v₀d₀zⱼ represents a geometric series with quotient x=(vⱼ₊₁dⱼ₊₁)/(vⱼdⱼ), wherein the function:

$${x}_{max} = 1 - {( \frac{{σ}_{max}}{0.8955} )}^{1 / 0.513}$$

represents the maximum preferred value of the quotient (x), wherein the quotient (x) can be tuned to the technical preferences for execution of the method, and the number Nⱼ′ of compartments in each library set (j) is set to an integer not smaller than the value determinable by the function:

$${N}_{j}^{′} = {( \frac{0.8955}{{σ}_{max}} )}^{2} {( 1 - x )}^{1.026}$$

and the number (N_{LIB}) of the separate library sets (j) is preferably set to an integer not smaller than the value determinable by the function

$${N}_{LIB} = {log}_{x} ( \frac{{C}^{-}}{{C}^{+}} ) + Δ {N}_{LIB}$$

wherein ΔN_{LIB} is determinable, preferably determined by the function

ΔN_{LIB}=4.5637(1−x)^{-0.798}

and wherein v₀d₀ is determinable, preferably determined by the function

$${v}_{0} {d}_{0} = ln 2 \cdot {x}^{- Δ {N}_{LIB} / 2} \cdot \frac{1}{{C}^{-}} .$$

with (C⁺), (C⁻) and (σ_{MAX}), as hereinbefore with respect to the first aspect of the invention and (d₀) and (v₀) as defined hereinbefore with respect to the inventive library approach.

With respect to the present invention the number N_{LIB} of compartments and ΔN_{LIB} represent an integer, wherein the integer is determined, which is close, preferably closest to the real result of the underlying function.

According to a furthermore preferred inventive method at least part or preferably each of the number (N_{LIB}) library sets (j) is assigned a value (kᵢ^{j}) being a function of at least part of, preferably all the values (kᵢ) assigned to each of the compartments contained in library set (j) in step d), and subsequently mapping the values (kᵢ^{j}) into a number, vector, matrix, tensor of any order or any other unambiguous representation of a microstate μ, wherein the number, vector, matrix, tensor of any order or any other representation comprises or consists of information reflecting at least part of the values (kᵢ^{j}), preferably comprises or consists of a vector k_{LIB}≡{kᵢ^{j}}, representing the microstate μ, wherein the vector (k_{LIB}) comprises or consists of at least part, preferably all of the values (kᵢ^{j}), wherein preferably the value (kᵢ^{j}) comprises or consists of the sum Kⱼ of the values (kᵢ) assigned to each of the compartments contained in library set (j) in step d).

3. According to a preferred embodiment of the present invention the determination of estimate of concentration E(C) of particles is characterized in that the following operations are performed:

e1) calculation of conditional probability p(μ|C) from the formula:

$$p ( μ \vert C ) = {\prod }_{j = 0}^{{N}_{LIB} - 1} \{ ( \begin{matrix}{N}_{j}^{′} \\ {K}_{j}\end{matrix} ) {( 1 - {e}^{- {z}_{j} {v}_{0} {d}_{0} C} )}^{{K}_{j}} {( {e}^{- {z}_{j} {v}_{0} {d}_{0} C} )}^{{N}_{j}^{′} - {K}_{j}} \}$$

e2) calculation of conditional probability p(C|μ) from the formula:

p(C|μ)=p(μ|C)·[∫_{C}_{ₘᵢₙ}^{C}^{ₘₐₓ}dC·p(μ|C)]⁻¹

where: Cₘᵢₙ=−C⁻ln(p_{TR})/ln(2), Cₘₐₓ=−C⁺ln(1−p_{TR})/ln(2), and: C⁻ means the lower limit of the interval for the determination of the unknown concentration C, C⁺ means the upper limit of the interval for the determination of the unknown concentration C, 0<p_{TR}<1 is a parameter specifying the assay precision, preferably P_{TR}→1; in the case the series of values vᵢdᵢ is a geometric series with quotient x<1, Cₘᵢₙ and Cₘₐₓ are preferably equal to: Cₘᵢₙ=C⁻x^{ΔN/2}, Cₘₐₓ=C⁺x^{-ΔN/2}, where ΔN=4.5637(1−x)^{-0.798}

e3) determination of the concentration C as the estimate E(C), where:

E(C)=∫_{C}_{ₘᵢₙ}^{C}^{ₘₐₓ}dC·C·p(C|μ)

with standard deviation σ(C)=\sqrt{E(C²)−E²(C)}·[E(C)]⁻¹, where:

E(C²)=∫_{C}_{ₘᵢₙ}^{C}^{ₘₐₓ}dC·C²·p(C|μ)

According to a further preferred embodiment of the inventive method, the number of copies of compartments in each library is equal Nⱼ′=N′, providing a convenient method for adjusting the technically preferable value x of the common ratio of the geometric progression and N′ while warranting the requested dynamic range and precision of the assay (see FIG. 2b and the respective part of the detailed figure description).

According to a further preferred embodiment of the inventive method, the signal is preferably measured in each compartment of the library with number i using the Real-Time PCR method and that compartment is assigned a real value that is dependent on the initial number of copies of target particle in that compartment, and subsequently the library with number i is assigned a value kᵢ specifying how many times more copies of the target particle are present in all compartments belonging to that library, than in certain arbitrarily selected positive compartment vₛₘᵢₙdₛₘᵢₙ, and the measured signal is mapped in the form of a vector k≡{kᵢ} specifying a microstate μ, containing consecutively the values of the parameter kᵢ, where i is the library number, running over integers from 0 to N−1.

4. According to a furthermore preferred inventive method according to the first aspect of the present invention, the method is characterised in that in step d) the total signal in all compartments from all libraries is measured, while each compartment i in the j-th library used in the assay is assigned a parameter kᵢ^{j} being a function of the signal measured in that compartment, and then the measured signal is mapped into a form of a value Kⱼ=Σᵢwᵢ^{j}kᵢ^{j} specifying a microstate μ, containing consecutively the values of the parameter Kⱼ, where j is the library number, running over integers from 0 to the number N_{lib}−1, and wᵢ^{j} is a summation weight, and preferably wᵢ^{j}=1 for each i and each j. In case of this preferred inventive method, the following operations are preferably performed in step e):

e1) calculation of conditional probability p(K|C) from the formula:

p(K|C)=Σ_{{k}_{ᵢ}_{}}[Πᵢ₌₀^{N}^{_{LIB}}⁻¹{(_{K}_{ᵢ}^{N′}^{ᵢ})(1−e^{-z}^{ᵢ}^{v}^{₀}^{d}^{₀}^{C})^{K}^{ᵢ}(e^{-z}^{ᵢ}^{v}^{₀}^{d}^{₀}^{C})^{N′}^{ᵢ}^{-K}^{ᵢ}}]

e2) calculation of conditional probability p(C|K) from the formula:

p(C|K)=p(K|C)·[∫_{C}_{ₘᵢₙ}^{C}^{ₘₐₓ}dC·p(K|C)]⁻¹
where: Cₘᵢₙ=−C⁻ln(p_{TR})/ln(2), Cₘₐₓ=−C+ln(1−p_{TR})/ln(2), and: C⁻ means the lower limit of the interval for the determination of the unknown concentration C, C⁺means the upper limit of the interval for the determination of the unknown concentration C, 0<p_{TR}<1 is a parameter specifying the assay precision; preferably p_{TR}→1;
in case the series of values vᵢdᵢ is a geometric series with quotient x<1, Cₘᵢₙ and Cₘₐₓ are equal to: Cₘᵢₙ=C⁻x^{ΔN/2}, Cₘₐₓ=C⁺x^{-ΔN/2}, where ΔN=4.5637(1−x)^{-0.798}.

e3) determination of the concentration C as the estimate E(C), where:

E(C)=∫_{C}_{ₘᵢₙ}^{C}^{ₘₐₓ}dC·C·p(C|K)

with standard deviation σ(C)=\sqrt{E(C²)−E²(C)}·[E(C)]⁻¹, where:

E(C²)=∫_{C}_{ₘᵢₙ}^{C}^{ₘₐₓ}dC·C^{p(C|K)}

Furthermore, in case the inventive method allows different standard deviations for different dynamic ranges, the following preferred inventive method is carried out, wherein the method is characterised in that the interval (C⁻, C⁺) is divided into q subintervals (Cₙ⁻, Cₙ⁺), preferably disjoint ones, in each subinterval the set of values dᵢvᵢ is a geometric series with quotient xₙ, and the libraries have constant cardinalities N′ₙ, whereas:

$$\begin{matrix}For {σ}_{{n}_{max}} < {σ}_{n - {1}_{max}} \\ {x}_{n} ( {N}_{n}^{′} ) = 1 - {( \frac{{σ}_{{n}_{max}}}{0.8955} \sqrt{{N}_{n}^{′}} )}^{1 / 0.513} \\ {N}_{n}^{′} ( {x}_{n} ) = {[ \frac{0.8955}{{{O}^{′}}_{{n}_{max}}} {( 1 - {x}_{n} )}^{0.513} ]}^{2} \\ Δ {N}_{{LIB}_{n}} = 4.5637 {( 1 - {x}_{n} )}^{- 0.798} \\ {N}_{{LIB}_{n}} = Δ {N}_{{LIB}_{n}} + {log}_{{x}_{n}} ( \frac{{C}_{n}^{-}}{{C}_{n}^{+}} ) \\ {d}_{{n}_{0}} {v}_{{n}_{0}} = ln 2 \cdot {x}_{n}^{- Δ {N}_{{LIB}_{n}} / 2} ( 1 / {C}_{n}^{-} ) & a ) \\ For {σ}_{{n}_{max}} > {σ}_{n - {1}_{max}} \\ {x}_{n} ( {N}_{n}^{′} ) = 1 - {( \frac{{σ}_{{n}_{max}}}{0.8955} \sqrt{{N}_{n}^{′}} )}^{1 / 0.513} \\ {N}_{n}^{′} ( {x}_{n} ) = {[ \frac{0.8955}{{σ}_{{n}_{max}}} {( 1 - {x}_{n} )}^{0.513} ]}^{2} \\ Δ {N}_{{LIB}_{n}} = 4.5637 {( 1 - {x}_{n} )}^{- 0.798} \\ {N}_{{LIB}_{n}} = 0.5 Δ {N}_{{LIB}_{n}} + 0.5 Δ {N}_{{LIB}_{n - 1}} + {log}_{{x}_{n}} ( \frac{{C}_{n}^{-}}{{C}_{n}^{+}} ) \\ {d}_{{n}_{0}} {v}_{{n}_{0}} = ln 2 \cdot {x}_{n - 1}^{- Δ {N}_{{LIB}_{n - 1}} / 2} ( \frac{1}{{C}_{n}^{-}} ) & b )\end{matrix}$$

Where C⁻ means the lower limit of the interval for the determination of the unknown concentration C, C⁺ means the upper limit of the interval for the determination of the unknown concentration C, Cₙ⁻ means the lower limit of the subinterval with the number n, Cₙ⁺ means the upper limit of the subinterval with the number n, σₙ_{ₘₐₓ} means the maximum permitted standard deviation of the estimate E(C) of the concentration C of particles in the subinterval (Cₙ⁻, Cₙ⁺), n is the subinterval number, running over integers from 1 to q, and i is the library number, running over integers from 0 to N_{LIB}_{ₙ}−1.

Preferably, the aforementioned calculations are performed with the use of a neural network.

According to another cumulatively or alternatively preferred embodiment of the present invention the inventive method can be used with respect to a multiplex PCR method. Accordingly, the inventive method is preferably used wherein the concentration of two or more different particles and/or two or more different parts of essentially the same particles are determined, wherein at least part, preferably all of the different particles and/or different parts of essentially the same particles that are present in any of the (N) compartments provide, preferably are amplified to provide two or more distinguishable measurable signals, wherein the two or more distinguishable signals in any of the (N) compartments are measured and wherein to each of the (N) compartments two or more different values are respectively assigned, wherein the different values independently from each other indicate that a threshold of a number of same particles and/or same parts of essentially the same particles is present in the compartment or not.

Another preferred embodiment of the present inventive method according to the first aspect of the present invention can be described as follows:

In potential applications of the digital quantitation assays the user is preferably interested in obtaining the estimate E(M) of number of particles in the sample. If the sample is divided into a set of N identical compartments, the appropriate algorithm for analysis of the outcome of the assay is to treat the stochastic distribution of particles between compartments as a distribution of dependant variables. The standard deviation of the estimate given by such analysis depends on the concentration E(Cₛₐₘₚₗₑ)=E(M)/Vₛₐₘₚₗₑ of particles in the sample and the estimate itself depends on the signal from the assay (see FIGS. 9a) and 9b) as well as the detailed figure description). In applications of the inventive method it is preferred that the relative standard deviation σ of the estimate is not larger than a known threshold within a given range of concentrations Cₛₐₘₚₗₑ=M/Vₛₐₘₚₗₑ. The relation between the dynamic range of concentrations Ω=C⁺/C⁻ and the maximum value of the relative standard deviation σ of the estimates within the range Cₛₐₘₚₗₑ ∈(C⁻, C⁺), Ω(σ) has a characteristic deflection point

$$\frac{{d}^{2} Ω}{d {σ}^{2}} = 0$$

that defines the optimum combination of the dynamic range Ω(N) and precision σ(N) as a function of the number of compartments N. A single assay comprising N compartments has the disadvantage that it does not allow to tune its dynamic range and precision independently of each other.

The inventors have unexpectedly found a solution to this problem that allows minimization of the total number of compartments for the required and independently predetermined dynamic range and precision of the estimate of concentration of particles E(C). The solution to this technical problem is to use a combination of assays, each comprising a number of identical compartments, with the volume and/or dilution factor of the compartments different between the assays. According to the invention, given the required values of the dynamic range (Ωₜₒₜ) of the combined assay and the maximum relative standard deviation (σ) of the estimate of the number of particles E(M) that can be expressed by the estimate of concentration E(Cₛₐₘₚₗₑ) returned by the assay, the parameters of the assay can be calculated with the use of the following simple scheme. The number N_{lib} of sets of identical compartments is given by:

$${N}_{lib} = \frac{log ( {Ω}_{tot} )}{log ( α \cdot {σ}^{β} )} .$$

The number (N′) of compartments in each set is preferably given by:

N′=γ·σ^{δ},

and the common factor x=dᵢ₊₁vᵢ₊₁/dᵢvᵢ of the geometric series of the modulation factor zᵢ=dᵢvᵢ/d₀v₀=xⁱ, where i∈(0, N_{lib}−1), characterizing compartments in different assays is preferably given by:

x=Ωₜₒₜ^{1/N}^{_{lib}}.

The value of the reference modulation factor z₀=d₀v₀ is preferably given by the expression:

z₀=(∈/C⁻)N^{φ}.

where the constants have the following values: α=0.1624, β=2.2307, γ=0.0328 and δ=−2.361, ∈=3.2605 and φ=−0.6166.

In alternatively preferred applications of the inventive method it may be preferred to estimate the concentration of particles in a large reservoir (e.g. of liquid or bodily fluids etc.) from which the specimen was taken. Then the placement of particles in the compartments is treated as a set of independent random variables being functions of the concentration of particles in the sample Cₛₐₘₚₗₑ=Cᵣₑₛₑᵣᵥₒᵢᵣ(V_{specimen}/Vₛₐₘₚₗₑ) and of the volumes and dilution ratios of the compartments. Then the estimate of concentration of particles delivered by the assay will describe the estimate E(Cᵣₑₛₑᵣᵥₒᵢᵣ)=E(Cₛₐₘₚₗₑ)(Vₛₐₘₚₗₑ/V_{specimen}) and the relative standard deviation σ of such an estimate. The appropriate algorithm for analysis of the outcome of the assay, is to treat the stochastic distribution of particles between compartments as a distribution of identical independently distributed variables. The standard deviation of the estimate given by such analysis depends on the concentration Cₛₐₘₚₗₑ=Cᵣₑₛₑᵣᵥₒᵢᵣ(V_{specimen}/Vₛₐₘₚₗₑ) and the estimate itself depends on the signal from the assay (see FIGS. 9a) and 9c) and respective part of the detailed figure description).

In alternatively preferred applications of the inventive method it is preferred that the relative standard deviation σ of the estimate is not larger than a known threshold within a given range of concentrations Cᵣₑₛₑᵣᵥₒᵢᵣ. The relation between the dynamic range of concentrations Ωₜₒₜ=Cᵣₑₛₑᵣᵥₒᵢᵣ⁺/Cᵣₑₛₑᵣᵥₒᵢᵣ⁻. The maximum value of the relative standard deviation σ of the estimates within the range Cₛₐₘₚₗₑ∈(C⁻, C⁺), Ω(σ) has a characteristic deflection point

$$\frac{{d}^{2} Ω}{d {σ}^{2}} = 0$$

that defines the optimum combination of the dynamic range Ω(N) and precision σ(N) as a function of the number of compartments N. A single assay comprising N compartments has the disadvantage that it does not allow to tune its dynamic range and precision independently of each other. The solution to this technical problem is to use a combination of assays, each comprising a number of identical compartments, with the volume and/or dilution factor of the compartments different between the assays. Ismagilov et al [Shen, F.; Sun, B.; Kreutz, J. E.; Davydova, E. K.; Du, W.; Reddy P. L.; Joseph, L. J.; Ismagilov, R. F., “Multiplexed Quantification of Nucleic Acids with Large Dynamic Range Using Multivolume Digital RT-PCR on a Rotational SlipChip Tested with HIV and Hepatitis C Viral Load”, J. Am. Chem. Soc., Article ASAP (X 2011)] have shown such a combination yet the solution provided did not minimize the number of compartments required to achieve a given set of values of the dynamic range and the relative standard deviation of the estimate of concentration. The present inventors have unexpectedly found a solution to this problem that allows minimization of the total number of compartments for the required and independently predetermined dynamic range and precision of the estimate of concentration of particles. According to the invention, given the required values of the dynamic range (Ωₜₒₜ=Cᵣₑₛₑᵣᵥₒᵢᵣ⁺/Cᵣₑₛₑᵣᵥₒᵢᵣ⁻) of the combined assay and the maximum relative standard deviation (σ) of the estimate of concentration E(Cₛₐₘₚₗₑ) returned by the assay, the parameters of the inventive method can be determined with the use of the following simple scheme. The number N_{lib} of sets of identical compartments is preferably given by:

$${N}_{lib} = \frac{log ( {Ω}_{tot} )}{log ( α \cdot {σ}^{β} )} .$$

The number (N′) of compartments in each set is preferably given by:

N′=γ·σ^{δ},

and the common factor x=dᵢ₊₁vᵢ₊₁/dᵢvᵢ of the geometric series of the modulation factor zᵢ=dᵢvᵢ/d₀v₀=xⁱ, where i∈(0, N_{lib}−1), characterizing compartments in different assays is preferably given by:

x=Ωₜₒₜ^{1/N}^{_{lib}}.

The value of the reference modulation factor z₀=d₀v₀ is preferably given by the expression:

z₀=[∈/(Cᵣₑₛₑᵣᵥₒᵢᵣ⁻(V_{specimen}/Vₛₐₘₚₗₑ))]N^{φ}.

where the constants have the following values: α=0.6813, β=−2.0966, γ=0.9925 and δ=−2.065, ∈=0.746 and φ=−0.2357.

In accordance with the second aspect of the present invention an apparatus for use in determining a concentration of particles in accordance with the inventive method is provided. All of the embodiments of the first aspect of the present invention can be combined independently from each other with respect to the second aspect of the invention.

The inventive apparatus enables the determination of the number (N) and the determination of the modulation factor (zᵢ) by suitable means. Suitable means are common apparatus, preferably comprising a computer with a memory device configured with executable instructions stored thereon, the instructions—when executed by a processor, cause the processor to determine the number (N) and the modulation factor (zᵢ) in accordance with the inventive method of the first aspect of the present invention. Thus, the inventive apparatus enables meeting the needs underlying the present invention at least partly.

In accordance with a cumulatively or alternatively preferred embodiment of the inventive apparatus the apparatus is configured to

c) partitioning at least part of the predetermined sample volume into the determined number (N) of separate compartments, wherein at least part, preferably all of the compartments comprise the predetermined sample volume with the determined modulation factor (zᵢ)

d) optionally amplifying the particles of the compartments with one or more suitable reagents and optionally one or more diluents for obtaining a measurable signal indicating the presence of a predetermined threshold number of particles, preferably one, two, three or more particles in a compartment,

e) measuring the signals in each of the (N) compartments and assigning to at least part, preferably all compartments a value (kᵢ), wherein (i) represents the index number of the compartments represented by integers 0 to N−1 and compartment (i) is assigned a first value (kᵢ), if the compartment (i) comprises or consists of the predetermined threshold number of particles or more, and compartment (i) is assigned a second value (kᵢ), if the compartment (kᵢ) comprises or consists of less than the threshold number of particles indicating the first value and

f) determining the estimated concentration of particles E(C), wherein the estimated concentration of particles E(C) is determined by a function of
i. a sum K of the values (kᵢ), wherein the function preferably is corrected using a calibration correction function, and/or
ii. a sum K of weighted values (wᵢkᵢ), wherein at least part of the values (kᵢ), preferably each value (kᵢ) is modulated with a weight value (wᵢ), wherein (i) represents the index number of the compartments represented by the integers 0 to N−1, and wherein the weight value (wᵢ) preferably is inversely proportional to the degree of volume and/or dilution of the number (i) of the compartments, and wherein the function is preferably corrected using a calibration correction function, and/or
iii. a number, vector, matrix, tensor of any order or any other unambiguous representation a microstate μ, wherein the number, vector, matrix, tensor of any order or any other representation comprises or consists of information reflecting at least part of the values (kᵢ) measured in step e), preferably comprises or consists of a vector k≡{kᵢ}, representing the microstate μ, wherein the vector (k) comprises or consists of at least part, preferably all of the values (kᵢ) measured in step e).

The preferred inventive apparatus enables carrying out both the determination of the number (N) and the determination of the modulation factor (zᵢ) by suitable means as described hereinbefore as well as the determination of the estimate of concentration E(C) by carrying out the optional amplification reaction with suitable means, the measurement of the values with suitable means, assignment of the first and second values kᵢ with suitable means as well as the actual determination of the final determination of the estimate of concentration E(C) by suitable means, such as a computer with a memory device configured with executable instructions stored thereon, the instructions—when executed by a processor, cause the processor to determine the estimate of concentration E(C) in accordance with the present invention.

Suitable means for configuring the preferred apparatus have been disclosed with respect to the first aspect of the present invention and can be combined independently from each other with the aforementioned preferred apparatus of the present invention.

According to a third aspect of the present invention the use of the inventive method or the inventive apparatus is provided for

a) adjusting, preferably reducing the total number (N) of compartments comprising the predetermined sample volume and/or

b) adjusting, preferably reducing the total volume of a mixture comprising or consisting of sample, one or more reagents suitable for amplifying at least part of the particles to a measurable signal and optionally one or more diluents in all of the (N) compartments and/or

c) predetermining the volume, preferably the minimum or maximum volume of the mixture comprising or consisting of sample, one or more reagents suitable for amplifying at least part of the particles to a measurable signal and optionally one or more diluents in each of the (N) compartments and/or

d) predetermining the modulation factor (zᵢ), preferably the minimum or the maximum suitable modulation factor (zᵢ) for partitioning the predetermined sample volume into the (N) compartments.

All the preferred embodiments of the first and second aspect of the present invention can independently from each other be combined with the embodiments of the third aspect of the present invention.

According to a fourth aspect of the present invention the sample holder for use in an inventive method or with an inventive apparatus is provided, wherein the sample holder is inventively configured to,

a) comprising or consisting of a predetermined number (N) of compartments wherein the number (N) is smaller or equal to the value of the function

$${N}_{MAX} = A \cdot ln ( \frac{{C}^{+}}{{C}^{-}} ) / {σ}_{MAX}^{2}$$

wherein (A) represents a real number being the integer 6, wherein (C⁺) represents a predetermined upper limit of the interval of concentration (C) to be estimated by the method, wherein (C⁻) represents a predetermined lower limit of the interval of concentration (C) to be estimated by the method, wherein (σ_{MAX}) represents a predetermined maximum allowable relative standard deviation of the estimate of concentration (C) of particles, wherein C⁻<C<C⁺, and

b) wherein the (N) compartments are configured to comprising the predetermined sample volume with a predetermined modulation factor (zᵢ), wherein (zᵢ) is a function of volumes (vᵢ) and dilution factors (dᵢ) of the sample in at least part of or all of the (N) compartments so that at least part of or all of the two or more of the (N) compartments can comprise or consist of different sample volumes (vᵢ) and/or different dilution factors (dᵢ) of the sample, wherein (i) represents an index number of the (N) compartments represented by the integers 0 to N−1, and wherein (vᵢ) represents the volume and (dᵢ) represents the dilution factor of the sample in the compartment (i).

All the preferred embodiments of the first, second and third aspect of the present invention can independently from each other be combined with the embodiments of the fourth aspect of the present invention.

Inventive sample holders can preferably comprise suitable test tubes, arrays of wells on a microarray, or a microfluidic chip, a microfluidic chip configured to generating droplets as well as other commercially available or otherwise generally known devices capable of holding discrete volumes and allowing amplification and measurement of respective signals.

The fifth aspect of the present invention relates to a kit comprising the inventive sample holder and one or more reagents suitable for amplifying at least part of particles comprised in the compartments of the sample holder to a measurable signal and optionally one or more suitable diluents for determining a concentration of particles, preferably for determining the concentration of particles in accordance with the inventive method.

All the preferred embodiments of the first, second, third and fourth aspect of the present invention can independently from each other be combined with the embodiments of the fifth aspect of the present invention.

### DETAILED DESCRIPTION OF THE FIGURES

FIGS. 1a). 1b) and 1c)

FIGS. 1a), 1b) and 1c) show the comparison of the performance of different digital assays designs.

In FIG. 1a) the shaded area shows the combinations of dynamic range and precision of the estimation of the concentration (expressed as the relative standard deviation of the estimate of concentration) achieved by inventive quantitation assays with volume of compartments determined by the geometrical sequence designed with x=1−α·σₘₐₓ^{β}, ΔN=γ·(1−x)^{-δ}, N=2·ΔN−logₓ(Ω) and v₀=ln 2·x^{-ΔN}1/C⁻, where α=1.24, β=1.9493, γ=4.5637 and δ=0.798. The grey lines show exemplary traces for a constant number of compartments in the geomteric assay. The black dotted line shows the possible combinations of relative standard deviation and dynamic range of the assay with identical compartments treated as identical and independent random variables, while the black dashed line indicates the same for the assay comprising Identical compartments treated as dependant random variables. Open square (□) indicates the assay comprising identical compartments treated as independent random variables and covering concentration range Ω=10⁶. Grey solid square (▪) indicates the assay comprising identical compartments treated as dependent random variables and covering concentration range Ω=10⁶.

FIG. 1b) shows the possible tuning of assays designed with the present inventive method while keeping the dynamic range constant and equal Ω=10⁶. The graph shows the minimum number of compartments as a function of the parameter p=ln(Ω)/σ² for the present inventive designs and designs from the state-of-art.

Long-dashed line represents inventive quantitation assays comprising sequence of volumes given by vᵢ=A·exp^{(B·i/N)} whereas A=1/C⁺ and =[1.95·ln {(C⁺/C⁻)/N)}]^{0.856} while the number of compartment in such assays are equal to

$$N = 2 \cdot {σ}_{MAX}^{- 1.9} \cdot {( \frac{{C}^{+}}{{C}^{-}} )}^{0.25} ) ,$$

and covering concentration range Ω=10⁶.

Dotted line represents inventing quantitation assays comprising more preferable

$$N = 2 \cdot {σ}_{MAX}^{- 1.94} \cdot {( \frac{{C}^{+}}{{C}^{-}} )}^{0.22}$$

compartments, and covering concentration range Ω=10⁶.

Solid line represents inventive quantitation assays with volume of compartments determined by the geometrical sequence designed with x=1−α·σₘₐₓ^{β}, ΔN=γ·(1−x)^{-δ}, N=2·ΔN−logₓ(Ω) and v₀=ln 2·x^{-ΔN}1/C⁻, where α=1.24, β=1.9493, γ=4.5637 and δ=0.798, and covering concentration range Ω=10⁶.

Dashed-dotted line represents inventive multivolume assays designed to provide the estimate of concentration (C_{R}) of particles in a reservoir of particles that is larger than the sample drawn from that reservoir. The assay is designed with the use of the following equations:

$${N}_{lib} = \frac{log ( {Ω}_{tot} )}{log ( α \cdot {σ}_{tot}^{β} )} , \\ {N}^{′} = γ \cdot {σ}_{tot}^{δ}$$

and x=Ω^{1/N}^{_{lib}}, where α=0.6813, β=−2.0966, γ=0.9925 and δ=−2.065, and covering concentration range Ω=10⁶.

Short-dashed (2) line represent multivolume quantitation assays designed to provide an estimate of the concentration (Cₛₐₘₚₗₑ) of particles in the sample. The assay is designed with the use of the following equations:

$${N}_{lib} = \frac{log ( {Ω}_{tot} )}{log ( α \cdot {σ}_{tot}^{β} )} , \\ {N}^{′} = γ \cdot {σ}_{tot}^{δ}$$

and x=Ω^{1/N}^{_{lib}} where α=0.1624, β=2.2307, γ=0.0328 and δ=−2.361, and covering concentration range Ω=10⁶.

Open square (□) indicates assay comprising identical compartments treated as independent random variables and covering concentration range Ω=10⁶.

Grey solid square (▪) indicates the assay comprising identical compartments treated as dependent random variables and covering concentration range Ω=10⁶.

FIG. 1c) shows a comparison of the number N of compartments required yielding a given dynamic range and precision in accordance with different designs of the assays relating to the present invention as well as relating to the prior art in comparison thereto. The number of compartments normalized by the function Nₘₐₓ=6p is plotted as a function of the parameter p=ln(Ω)/σ².

Open (⋄) and solid (♦) black rhombs show the performance of the inventive assays in which compartment volumes are determined by geometric progression of the modulation factors, with

$${v}_{i} = A \cdot {exp}^{( B \cdot \frac{i}{N} )}$$

whereas A=1/C⁺ and=[1.95·ln {(C⁺/C⁻)/N}]^{0.856}. The number of compartments in such assays are equal to

$$N = 2 \cdot {σ}_{MAX}^{- 1.9} \cdot {( \frac{{C}^{+}}{{C}^{-}} )}^{0.25}$$

(assays marked with solid black rhombs ♦), or preferably

$$N = 2 \cdot {σ}_{MAX}^{- 1.94} \cdot {( \frac{{C}^{+}}{{C}^{-}} )}^{0.22}$$

(assays marked with open black rhombs ⋄).

Solid triangles (▴) represent inventive quantitation assays with volume of compartments determined by the geometrical sequence designed with x=1−α·σₘₐₓ^{β}, ΔN=γ·(1−x)^{-δ}, N=2·ΔN−logₓ(Ω) and v₀=ln 2·x^{-ΔN}1/C⁻, where α=1.24, β=1.9493, γ=4.5637 and δ=0.798.

Open triangles (Δ) represent inventive quantitation assays with volume of compartments determined by the geometric sequence with repetitions (or N′ copies of each compartment), where for a given number of copies (N) the common factor of the geometric series has a value x=1−α·(σₘₐₓ\sqrt{N′})^{β}, and all other parameters are defined in the same way as for the geometric series without repetitions.

Open black circles (∘) represent the number of compartments of an inventive multivolume assays designed to provide the estimate of concentration (Cᵣₑₛₑᵣᵥₒᵢᵣ) of particles in a reservoir of particles that is larger than the sample drawn from that reservoir. The assay is designed with the use of the following equations:

$${N}_{lib} = \frac{log ( {Ω}_{tot} )}{log ( α \cdot {σ}_{tot}^{β} )} , \\ {N}^{′} = γ \cdot {σ}_{tot}^{δ}$$

and x=Ω^{1/N}^{_{lib}}, where α=0.6813, β=−2.0966, γ=0.9925 and δ=−2.065.

Solid black circles () represent multivolume quantitation assays designed to provide an estimate of the concentration (Cₛₐₘₚₗₑ) of particles in the sample. The assay is designed with the use of the following equations:

$${N}_{lib} = \frac{log ( {Ω}_{tot} )}{log ( α \cdot {σ}_{tot}^{β} )} , \\ {N}^{′} = γ \cdot {σ}_{tot}^{δ}$$

and x=Ω^{1/N}^{_{lib}}, where α=0.1624, β=2.2307, γ=0.0328 and δ=−2.361.

Plus-signs and with dashed line represent the performance of the multivolume assays of the prior art described by R. F. Ismagilov in F. Shen, R. F. Ismagilov et al., JACS 2011 133: 17705-17712.

The black solid line shows the clear demarcation line between the solution provided by Ismagilov and the more technically favorable solutions disclosed in this application. The distinction between the quantitation assays described here and multivolume assays presented previously is clearly seen.

FIGS. 2a) and 2b)

FIG. 2 a) shows a graph of the dynamic range C⁺/C⁻=Ω and relative standard deviation σ provided by the inventive quantitation assay comprising N compartments with volumes determined by the geometrical sequence with common ratio (or quotient) x. The dynamic range C⁺/C⁻=Ω can be tuned independently of the precision σ, and for a given required dynamic range, the assays proposed require even 10², to 10⁴ times less compartments than the standard digital assays.

FIG. 2b) shows a graph displaying the relation between the common ratio x of the geometrical sequence determining the volumes of the compartments of the inventive assay and number of copies of each compartment in inventive assays that provide the maximum relative standard deviations σ(C) of the estimate E(C). For any predetermined dynamic range, and precision, the factor x of geometric progression of volumes can be interchanged with the number N′ of copies of the compartments allowing to tuning the design of the assay to the technical requirements in its realization.

FIGS. 3a). 3b), 3c) and 3d)

FIG. 3a) shows an inventive assay comprising compartments of different volumes, each compartment addresses its own characteristic concentration C. Equivalently, for any arbitrary input concentration C* only one of the compartments addresses this concentration most closely. The progressively larger (or smaller) compartments carry progressively less information about the input concentration. This is reflected in that the probability of obtaining a signal from these compartments approaches unity (or zero). The active stripe (here marked with the grey dashed rectangle and comprising compartments with v_{i*-1}, v_{i*}, v_{i*+1}) is defined as a finite set of compartments characterized by probability of giving a signal significantly different than zero or one. Compartments outside of the active stripe with a larger volume than in the active stripe (dark grey marked compartments with v_{i*-2}, v_{i*-3}, v_{i*-4}) comprise a probability that always a positive signal, i.e., indicating that at least the threshold amount will be measured, whereas for compartments outside the active stripe comprising a smaller volume than in the active stripe (light grey marked compartments with v_{i*+2}, v_{i*+3}, v_{i*+4}) comprise a probability that always a negative signal, i.e., indicating that less than the threshold amount will be measured.

FIG. 3b) shows an active stripe in accordance with the present invention comprising a set of test-volumes yields stochastic combinations of signals (microstates) in every run of the assay, wherein the integer 1 indicates that at least the threshold amount of particles, preferably at least 1 particle is present in the compartment and the integer 0 indicates that less than the threshold amount, preferably no particle is present in that compartment. Each microstate yields ρ_{μ}^{ᵢ}=ρ(C|μᵢ) that provide more information than that (ρ_{K}) retrieved from the sole number of values K. Each of these distributions are characterized by a different standard deviation (i.e. different information about C). The envelope (i.e. the maximum value) of the standard deviation of the distribution ρ(C) is given by the most probable microstate. In accordance with the summation (Δ) and microstate (♦) approach this is illustrated for an active stripe comprising three compartments in FIG. 3c) and sixteen compartments in FIG. 3d). Interestingly, many of the less probable microstates carry significantly more information about C than the most probable ones.

FIGS. 4a), 4b) and 4c)

FIGS. 4a), 4b), 4c) show graphs displaying the standard deviation of the estimate of concentration of particles, for two different approaches (summation (Δ) and microstate (♦) approach) of analyzing the signals from the compartments in accordance with the inventive method. The triangles show the standard deviation of the estimate of concentration of particles derived from the sum of the value K=Σᵢ₌₀^{N-1}kᵢ (summation), while the rhombs show the standard deviation of the estimate of concentration of particles derived from each unique microstate μ={kᵢ} that is possible for a given value of K. For the vast majority of the possible microstates the standard deviation of the concentration of the particles derived from the microstates is smaller than that based on the sum of values. Each graph corresponds to a different assay with a different quotient of the geometric series dᵢ₊₁vᵢ₊₁=x(dᵢvᵢ).

FIGS. 5a) and 5b)

FIG. 5a) shows a graph displaying the probability distributions p(μ|C) for the ten most frequently occurring microstates (grey lines) of the inventive quantitation assay of the sample with a volume of 20 μL, designed so as to offer the estimate of the concentration of particles with a relative standard deviation less than σₘₐₓ=62% in the concentration range from C⁻=1 mL⁻¹ to C⁺=10² mL⁻¹, i.e., C⁺/C⁻=10². The required dynamic range is accomplished by partitioning the sample into 10 partitions with dilution ratios Cᵢ/C_{S}=dᵢ=xⁱ, where x=0.5. The black line marks the microstate, in which the first five compartments show the presence of at least one copy of the target particle. The width of the distribution defines the measurement precision, in this case equal to 62%. Each curve shown in the Figure results from the product of terms (1−e^{-v}^{ᵢ}^{C}) for positive partitions and e^{-v}^{ᵢ}^{C} for negative partitions that form a steep ridge on the left side (positive partitions), and on the right side (negative partitions), respectively.

FIG. 5b) shows a graph displaying the probability distributions p(μ|C) for the first 90 most frequently occurring microstates (grey lines) of the inventive quantitation assay of the sample with a volume of 20 μL, designed so as to offer the estimate of the concentration of DNA particles in the said sample with a relative standard deviation less than σₘₐₓ_{_{—}}₁₌62% in the concentration range from C₁⁻=10² [1/mL] to C₁⁺=10⁴ [1/mL], i.e., (C₁⁺/C₁⁻)=10², σₘₐₓ_{_{—}}₂=25% in the concentration range from C₂⁻=10⁴ [1/mL] to C₂⁺=10⁶ [1/mL], i.e., (C₂⁺/C₂⁻)=10², and σₘₐₓ_{_{—}}₃=62% in the concentration range from C₃⁻=10⁶ [1/mL] to C₃⁺=10⁸ [1/mL], i.e., (C₃⁺/C₃⁻)=10². The required dynamic range is accomplished by partitioning the sample into consecutively 14 compartments with dilution ratios Cᵢ/C_{S}=dᵢ=xⁱ, where x=0.5, 86 compartments with x=0.917, and 14 compartments with x=0.5. Using numerical algorithms presented in the description of the invention, the estimate E(C_{S}) is calculated based on the conditional probability distribution p(C_{S}|μ), where μ is a microstate of the system of partitions used to perform the analytical assay. The black line marks two microstates; in the first one (on the left) the first seven 7 partitions show the presence of at least one copy of the target particle, while the remaining ones are negative, in the second case (on the right)—the first 57 partitions show the presence of at least one copy of the target particle, while the remaining ones are negative. One can easily differentiate the microstates from the first group (x=0.5), and from the second group (x=0.917). The microstates from the second group are dearly narrower (which results in a higher precision of the assay) and occur more densely on the concentration axis.

FIG. 6

FIG. 6 shows a graph displaying the calibration correction function ƒ_{corr}=C/E(C) of initial concentration

$$C = \frac{M}{V}$$

of particles for the inventive quantitation assay comprising 2,814 compartments with dilution factors

$${d}_{i} = \frac{{c}_{i}}{c} = {x}^{i} ,$$

where x=0.99814, where signals from compartments are weighted by the factor wᵢ=1/dᵢ.

FIGS. 7a). 7b) and 7c)

FIG. 7a) shows a graph displaying the sum of values K=Σwᵢkᵢ, with weights wᵢ=1/dᵢ as a function of the number of particles M randomly distributed over N=2,814 compartments in accordance with the inventive method. The compartments, indexed i, are characterized by dilution factors

$${d}_{i} = \frac{{c}_{i}}{c} = {x}^{i} ,$$

with the quotient of the geometric series x=0.99814. The number of compartments and the quotient x are selected so that the quantitation assay offers an estimate of concentration of particles c=E(C) with a maximum relative standard deviation less than σ_{MAX}=10% within a dynamic range of concentrations C⁺/C⁻=10⁵. The results presented in FIG. 1 are obtained form 100 iterations of the numerical algorithm.

FIG. 7b) shows a graph displaying the value of the estimate E(C) of initial concentration of particles as a function of K, where K is the sum of weighted signals K=Σwᵢkᵢ. with weights wᵢ=1/dᵢ for the inventive quantitation assay comprising 2,814 compartments with dilution factor

$${d}_{i} = \frac{{c}_{i}}{c} = {x}^{i} ,$$

where x=0.99814.

FIG. 7c) shows a graph displaying the relative standard deviation σ(C) of the estimate E(C) as a function of the logarithm of initial concentration C=M/V of particles for the inventive quantitation assay comprising 2,814 compartments with dilution factors

$${d}_{i} = \frac{{c}_{i}}{c} = {x}^{i} ,$$

where x=0.99814, where signals from compartments are weighted by the factor wᵢ=1/dᵢ.

FIGS. 8a). 8b) and 8c)

The graphs of FIGS. 8a), 8b) and 8c) show the results of 100 Monte Carlo (MC) simulations for each of the following assays and 7 or 8 experiments as experimental and numerical verification of the performance of the inventive method (see also example section). In accordance with the present invention a set of geometric assays, with varied dynamic ranges and precision: (i) Ω=10³, σ≦80%, N=10, x=0.50, (ii) Ω=10², σ≦60%, N=10, x=0.60, and (iii) Ω=10¹, σ≦25%, N=30, x=0.92 has been designed. Each of the above inventive assays was verified with a Monte Carlo simulation. In addition, the inventive quantitation assays were run experimentally. For each inventive assay the trails were done with a single fixed value of the input concentration Cᵢₙₚᵤₜ: 1420, 568 and 66 [particles/mL] for a, b and c, respectively. The results from MC are shown as black lines showing the 70% confidence interval (E(C)±σ).

The expected values retrieved from the signals from the experimental assays are shown with red rhombs and the 70% confidence intervals with the error bars. The grey stripes show the range of Cᵢₙₚᵤₜ±σₘₐₓ.

FIGS. 9a) and 9b)

The graphs of FIGS. 9a) and 9b) show the standard deviation of the estimate of concentration/number of molecules in the sample based on i.i.d. (dashed line) and non-i.i.d. approach (solid line) and the estimate of concentration itself as a function of signal. Dotted lines show the exemplary threshold values of the standard deviation of the estimate. For each threshold one can univocally determine the dynamic range Ω=C⁺/C⁻, where C⁻ is the minimum and C⁺ is the maximum concentration assayed with at least the required precision. The ‘wavy’ behavior of the sigma distribution for non-i.i.d. approach is caused by computing accuracy.

Further Embodiments of the Invention Part B:

1. A method for determination of the concentration of particles in a sample, comprising the following steps:

a) division of the sample into N disjoint sub-volumes, each having volume of vᵢ, where i is the index of the sub-volume, wherein
either the sample is divided into sub-volumes in a deterministic way, i.e. such that the volumes vᵢ are given by a sequence of values of an analytical function ƒ(i) or by a predefined set of values,
or the sample is divided into sub-volumes in a random way, i.e. such that the distribution of volumes of the sub-volumes corresponds to a probability distribution P(v), meaning that the number of sub-volumes having the volume of vᵢ in the range (v, v+Δv) is given by the expression: N ∫ᵥ^{v+DvP}(v)dv;

b) conducting in each of the thus obtained sub-volumes the process of amplification of the presence of at least one said particle to a measurable signal;

c) measuring said signal in each of the sub-volumes and assigning to this sub-volume the parameter kᵢ, wherein the parameter kᵢ has the value equal to 1, if the result of said signal measurement indicates that in the given sub-volume there is at least one said particle and has the value equal to 0 otherwise, and i is the number of the sub-volume;

d) calculating the sum K=Σkᵢ·wᵢ(vᵢ), where i is the number of the sub-volume and the sum is over all the sub-volumes into which the sample was divided i=1 . . . N, and wᵢ(vᵢ) is a weight, which may depend on the volume of the sub-volume;

e) determination of an estimate E(C) of the concentration of said particles in the sample based on the values of K, N and {v}) or P(v), with a known statistical algorithm based on the Bayes formalism,

characterized in that, the division of the sample in step a) includes at least two sub-volumes having different volumes.

The disclosure with respect to the invention underlying Polish patent application PL 397028 (filed: 17 Nov. 2011; title: “Sposób przeprowadzania cyfrowych oznaczeń analitycznych i diagnostycznych”) in particular including all preferred embodiments and examples thereof and the relating figures are incorporated herein in its entirety and display also further inventive embodiments with respect to the present invention.

2. Further Embodiments of the Invention Part C:

1. A method for determination of the concentration of particles in a sample, comprising the following steps:

a) division of the sample into N disjoint sub-volumes, each having volume of vᵢ, where i is the index of the sub-volume, wherein
either the sample is divided into sub-volumes in a deterministic way, i.e. such that the volumes vᵢ are given by a sequence of values of an analytical function ƒ(i) or by a predefined set of values,
or the sample is divided into sub-volumes in a random way, i.e. such that the distribution of volumes of the sub-volumes corresponds to a probability distribution P(v), meaning that the number of sub-volumes having the volume of vᵢ in the range (v, v+Δv) is given by the expression: N ∫ᵥ^{v+Δv}P(v)dv;

b) conducting in each of the thus obtained sub-volumes the process of amplification of the presence of at least one said particle to a measurable signal;

c) measuring said signal in each of the sub-volumes and assigning to this sub-volume the parameter kᵢ, wherein the parameter kᵢ has the value equal to 1, if the result of said signal measurement indicates that in the given sub-volume there is at least one said particle and has the value equal to 0 otherwise, and i is the number of the sub-volume;

d) determination of an estimate m of the concentration of said particles in the sample based on the set of values {kᵢ}, N and {vᵢ} or P(v) with known statistical algorithms;

2. characterized in that the volume vᵢ of each of the N sub-volumes into which the sample is divided in the step a) is different.

The disclosure with respect to the invention underlying Polish patent application PL 397027 (filed: 17 Nov. 2011; title: “Sposób przeprowadzania cyfrowych oznaczeń analitycznych i diagnostycznych”) in particular including all preferred embodiments and examples thereof and the relating figures is incorporated herein in its entirety and display also further inventive embodiments with respect to the present invention.

3. Further Embodiments of the Invention Part D:

1. A method for determination of an unknown concentration C_{P} of particles in a sample having a known volume V_{P}, comprising the following steps:

a) mixing the sample having the volume of V_{P} with the volume of V_{R} of a solution of reagents required for conducting a reaction of amplification of the presence of at least one of said particles to a measurable signal, as a result of which a reactive solution having the volume of V_{S} containing unknown concentration C_{S}=C_{P}·V_{P}/(V_{P}+V_{R}) of said particles is obtained,

b) creating, from the reactive solution having the volume of V_{P} and of the additional solution of reagents required for conducting of the reaction of amplification of the presence of at least one of said particles to a measurable signal, N of disjoint sub-volumes having the volume of u each, in such a way that each of those sub-volumes comprises the required concentration of reagents and a given dilution dₙ of said particles, where

$${d}_{n} = \frac{{c}_{n}}{{c}_{0}} ,$$

where the index n indexes the sub-volumes and goes over the integer numbers from 0 to N−1, and Cₙ denotes the unknown concentration of said particles in the sub-volume having the number n,

c) conducting in each of the thus obtained sub-volumes the process of amplification of the presence of at least one of said particles to a measurable signal;

d) measuring said signal in each of the sub-volumes and assigning to this sub-volume the parameter kₙ, wherein the parameter kₙ has the value equal to 1, if the result of said signal measurement indicates that in the given sub-volume there is at least one said particle and has the value equal to 0 otherwise, and n is the number of the sub-volume;

e) determination of the estimate E(C_{S}) of the concentration of said particles in the reactive solution having the volume of V_{S}, based on the set of values of {kₙ}, N and {dₙ}, using a known statistical algorithm, preferably based on the Bayes formalism,

f) determination of the concentration C_{P} from the formula: C_{P}=C_{S′}(V_{P}+V_{R})/V_{P}

2. characterized in that for at least two of the sub-volumes mentioned in the step b) the dilutions dₙ are different.

The disclosure with respect to the invention underlying Polish patent application PL 397026 (filed: 17 Nov. 2011; title: “Sposób przeprowadzania cyfrowych oznaczeń analitycznych i diagnostycznych”) in particular including all preferred embodiments and examples thereof and the relating figures is incorporated herein in its entirety and display also further inventive embodiments with respect to the present invention.

3. Further Embodiments of the Invention Part E:

1. A method for determining unknown concentration C_{S} of particles in a sample of known volume V_{S}, comprising the following steps:

a) partitioning the said sample into N separate compartments of volume vᵢ and dilution dᵢ each, by mixing of at least a fraction of the sample with certain volume of the solution of reagents required to carry out the reaction amplifying the presence of at least one target particle to a measurable signal, where 0<dᵢ≦0 means the dilution factor, i.e., the ratio of the concentration Cᵢ of particles in a given compartment to the unknown concentration C_{S} of particles in the sample, dᵢ=Cᵢ/C_{S}, and i is the compartment number, running over integers from 0 to N−1;

b) performing in each compartment so produced a process amplifying the presence of at least one said particle to a measurable signal;

c) measurement of the said signal in each compartment and assigning to the said compartment a parameter kₙ, said parameter kᵢ assuming a value of 1, if the result of the said measurement indicates that a given compartment contains at least one said particle, and 0 in the opposite case;

d) constructing a vector k≡{kᵢ}, specifying a microstate μ, containing in sequence the values of kᵢ parameter measured in step c);

2. characterised in that

e) the unknown concentration C_{S} of particles in a sample is calculated as an estimate being a function of the vector k constructed in step d) and specifying the microstate μ: E(C_{S})=ƒ(μ), whereas at least two from among the compartments produced in step a) differ from each other by the value of the modulation factor zᵢ, equal to the quotient zᵢ=(vᵢdᵢ)/(v₀d₀).

The disclosure with respect to the invention underlying Polish patent application PL 399673 (filed: 26 Jun. 2012; title: “Sposób przeprowadzania cyfrowych oznaczeń analitycznych i diagnostycznych”) in particular including all preferred embodiments and examples thereof and the relating figures is incorporated herein in its entirety and display also further inventive embodiments with respect to the present invention.

3. Further Embodiments of the Invention Part F:

1. A method for determining the unknown concentration C_{S} of particles in a sample of known volume V_{S}, comprising the following steps:

a) partitioning the sample into N sets of separate compartments, referred to as libraries, whereas each set contains N′ᵢ>0 compartments and within each set the value of the expression dᵢvᵢ is set by mixing of at least a fraction of the sample with certain volume of the solution of reagents required to carry out the reaction amplifying the presence of at least one target particle to a measurable signal, where: vᵢ means the volume of a given compartment, dᵢ>0 means the dilution factor, i.e., the ratio of the concentration Cᵢ of particles in a given compartment to the unknown concentration C_{S} of particles in the sample, dᵢ=Cᵢ/C_{S}, and i is the library number, running over integers from 0 to N−1;

b) performing in each compartment of each library so produced a process amplifying the presence of at least one said particle to a measurable signal;

c) measurement of the said signal in each compartment and mapping the measured signal in a form of a number, vector, matrix, or tensor of any order, specifying a microstate μ, in which the indexes unambiguously identify each compartment with given dilution factor dᵢ and with given volume vᵢ, and the values of components with given set of indexes map the signal value from that compartment;

2. characterised in that

d) the unknown concentration C_{S} of particles in a sample is calculated as the estimate being a function of the said number, vector, matrix, or tensor of any order, obtained in step c) and specifying the microstate μ: E(C_{S})=ƒ(μ), whereas at least two from among the libraries produced in step a) differ from each other by the value of the modulation factor zᵢ, equal to the quotient zᵢ=(vᵢdᵢ)/(v₀d₀).

The disclosure with respect to the invention underlying Polish patent application PL 399908 (filed: 11 Jul. 2012; title: “Sposób przeprowadzania cyfrowych oznaczeń analitycznych i diagnostycznych”) in particular including all preferred embodiments and examples thereof and the relating figures is incorporated herein in its entirety and display also further inventive embodiments with respect to the present invention.

### EXAMPLES

In the preferred embodiments of the invention the assays to determine quantitatively the Epstein-Barr virus DNA are performed. The replicated sequence is a fragment of a highly conservative EBNA-1 gene with a length of 218 base pairs. The primers with the following sequences were used: forward primer: CTATATGCCTGCTTCCTCCGG CGGACCCGGCCCACAACCTGGC, and reverse primer: CGCCGGAGGAAGCAGGCATATAG CGACTCAATGGTGTAAGACGAC. The method was validated by analysing the consistency of assays to determine the DNA concentration for calibrators (plasmid solutions containing EBNA-1 amplicon) used in the real-time PCR reaction with concentration from 10 copies to 10,000 copies per reaction.

A reaction mixture of volume Vₛₐₘₚₗₑ=20 μL contains each 4 μl water, 1 μl Primer 10×, 10 μl Master Mix (Hot start DNA, Taq polymerase, dNTP mix, MgCl₂), 5 μl DNA template at concentration (20/5)Cₛₐₘₚₗₑ [copies/mL]. For each experiment, the required volume of a mixture used to dilute the said reaction mixture is also prepared.

In a non-limiting example, the reaction mixture of volume V_{S}=20 μL and the required volume of the mixture of reagents used to dilute the sample are deposited in a microfluidic system made of PDMS or polycarbonate. Then, droplets containing the sample solution of volumes {u_{Si}} and droplets containing the reaction reagents of volumes {u_{Ri}} are generated on-demand so as to obtain, after merging the droplets with the same indices (u_{Si}+u_{Ri}≡u), a series of droplets of constant volume u and of a defined progression of unknown concentrations of target molecules Cᵢ=Cₛₐₘₚₗₑ(u_{Si}/u).

In a non-limiting example, the mixture so prepared is pipetted after dilution to test tubes in strips 20 μl each. After centrifugation, the strips are placed in a LightCycler Nano apparatus.

The following reaction protocol is used: 10 minutes initial denaturation at 95° C., followed by 45 cycles composed of a 30 s denaturation at 95° C., 30 s annealing at 55° C. and 30 s elongation at 72° C. The entire procedure is completed by cooling the chip down to 20° C. The partitions displaying high fluorescence level in the channel 530-548 nm are counted.

### Executive Example 1

In a preferred embodiment, a quantitation assay for a sample with a volume of 20 μL is designed so as to offer the estimate of the concentration of DNA molecules in the said sample with a relative standard deviation less than σₘₐₓ=62% in the concentration range from C⁻=1 mL⁻¹ to C⁺=10² mL⁻¹, i.e., C⁺/C⁻=10². The assay returns the concentration of the sample calculated with the use of independent random variables, thus, via scaling the estimate of concentration in the sample can be translated into the estimate of concentration in a reservoir. The required dynamic range is accomplished by partitioning the sample into 10 partitions with dilution ratios Cᵢ/Cₛₐₘₚₗₑ=dᵢ=xⁱ, where x=0.5. Using numerical algorithms presented in the description of the invention, the estimate E(Cₛₐₘₚₗₑ) is calculated based on the conditional probability distribution ƒ(Cₛₐₘₚₗₑ|/μ), where μ is a microstate of the system of partitions used to perform the analytical assay (see also FIG. 5a) and respective part of the detailed figure description).

In a preferred embodiment, the number of Epstein-Barr DNA copies is determined using a sample with a volume of 20 μL. The reaction mixture is placed in a system made of PDMS/polycarbonate and 10 droplets on demand with dilution ratios dᵢ=xⁱ, where x=0.5, are generated. The system with droplets is placed in a thermocycler, the PCR reaction is carried out, and subsequently the signals from each droplet (microstate of the system) are read out.

For example, a 20 μL sample containing gene copies at a concentration of Csₛₐₘₚₗₑ=55.5 mL⁻¹ was used. In five repeated experiments the following results were obtained: in the first trial μ₁={1,1,1,1,1,0,0,0,0,0}, in the second one μ₂={1,1,1,1,0,0,0,0,1,0}, in the third one μ₃={1,1,1,0,0,0,0,0,0,0}, in the fourth one μ₄={1,1,1,0,0,0,0,0,0,0}, and in the fifth one μ₅={1,1,0,1,0,0,0,0,0,0}, where the index numbers the repetition of the experiment. Using the statistical model obtained for a given distribution of dilutions, these values are recomputed into the estimates cₗ=Eₗ(Cₛₐₘₚₗₑ) of the initial concentration of DNA copies in the sample c₁=56.8, c₂=45.2, c₃=34.8, c₄=34.8 and c₅=27.9 mL⁻¹.

### Executive Example 2

In a preferred embodiment, a quantitation assay for a sample with a volume of 20 μL is designed so as to offer the estimate of the concentration of DNA molecules in the said sample with a relative standard deviation less than σₘₐₓ=25% in the concentration range from C⁻=5 mL⁻¹ to C⁺=5·10² mL⁻¹, i.e., C⁺/C⁻=10². The assay returns the concentration of the sample calculated with the use of independent random variables, thus, via scaling the estimate of concentration in the sample can be translated into the estimate of concentration in a reservoir. The required dynamic range is accomplished by partitioning the sample into 86 partitions with dilution ratios dᵢ=xⁱ, where x=0.917. Using numerical algorithms presented in the description of the invention, the estimate E(Cₛₐₘₚₗₑ) is calculated based on the conditional probability distribution ƒ(Cₛₐₘₚₗₑ|μ), where μ is a microstate of the system of partitions used to perform the analytical assay. In a preferred embodiment, the number of Epstein-Barr DNA copies is determined using a sample with a volume of 20 μL. The reaction mixture is placed in a system made of PDMS/polycarbonate and 86 droplets on demand with dilution ratios dᵢ=xⁱ, where x=0.917, are generated. The system with droplets is placed in a thermocycler, the PCR reaction is carried out, and subsequently the signals from each droplet (microstate of the system) are read out.

For example, a 20 μL sample containing gene copies at a concentration of Cₛₐₘₚₗₑ=1.5·10² mL⁻¹ was used. In five repeated experiments the following results were obtained: in the first trial μ₁={1,1,1,1,1,1,1,1,1,1,1,1,1,1,1,1,1,1,1,1,1,1,1,1,1,1,1,1,1,1,1,1,1,1,1,1,1,1,1,0,1,1,1,1,1, 1,1,1,0,0,1,1,0,1,1,1,1,1,1,0,1,1,0,1,1,1,0,0,0,0,1,0,0,0,0,0,0,0,1,0,0,1,0,1,0,1}, in the second one μ₂={1,1,1,1,1,1,1,1,1,1,1,1,1,1,1,1,1,1,1,1,1,1,1,1,1,1,1,1,1,1,1,1,1,1,1,1,1,1,1,1,1,0,1,1,1,1, 1,1,0,0,1,1,0,1,1,1,1,1,1,1,0,1,1,1,1,0,1,0,0,0,0,0,1,0,0,1,0,0,0,1,1,1,0,0,1,0}, in the third one μ₃={1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,0,0,1, 1,1,0,1,1,1,1,1,1,1,1,0,1,1,0,1,0,1,1,0,1,0,0,1,0,0,0,0,1,0,0,0,0,0,0,0,0}, in the fourth one μ₄={1,1,1,1,1,1,1,1,1,1,1,1,1,1,1,1,1,1,1,1,1,1,1,1,1,1,1,1,1,1,1,1,1,1,1,1,1,1,1,1,0,1,1,1,0,1,1,0,1,1, 1,1,0,1,1,1,1,0,1,1,1,1,1,0,0,0,1,1,1,1,1,0,0,0,0,0,0,1,0,0,0,0,0,0,1,1}, and in the fifth one μ₅={1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,0,0, 1,1,0,0,0,1,0,0,1,0,0,1,1,1,1,1,0,1,1,1,1,1,0,0,1,0,0,1,0,1,1,1,0,0,1,0,1,1}, where the index numbers the repetition of the experiment. Using the statistical model obtained for a given distribution of dilutions, these values are recomputed into the estimates Cₗ=Eₗ(Cₛₐₘₚₗₑ) of the initial concentration of DNA copies in the sample c₁=1.51·10², c₂=1.72·10², c₃=1.52·10², c₄=1.61·10² and c₄=1.84·10² [mL⁻¹].

### Executive Example 3

In a preferred embodiment, a quantitation assay for a sample with a volume of 20 μL is designed so as to offer the estimate of the concentration of DNA molecules in the said sample with a relative standard deviation less than σₘₐₓ_{_{—}}₁=62% in the concentration range from C₁⁻=10² [1/mL] to C₁⁺=10⁴ [1/mL], i.e., (C₁⁺/C₁⁻)=10², σmax_{_{—}}₂=25% in the concentration range from C₂⁻=10⁴ [1/mL] to C₂⁺=10⁶ [1/mL], i.e., (C₂⁺/C₂⁻)=10², and σₘₐₓ_{_{—}}₃=62% in the concentration range from C₃⁻=10⁶ [1/mL] to C₃⁺=10⁸ [1/mL], i.e., (C₃⁺/C₃⁻)=10². The assay returns the concentration of the sample calculated with the use of independent random variables, thus, via scaling the estimate of concentration in the sample can be translated into the estimate of concentration in a reservoir. The required dynamic range is accomplished by partitioning the sample into consecutively 14 partitions with dilution ratios dᵢ=xⁱ, where x=0.5, 86 partitions with x=0.917, and 14 partitions with x=0.5. Using numerical algorithms presented in the description of the invention, the estimate E(Cₛₐₘₚₗₑ) is calculated based on the conditional probability distribution p(Cₛₐₘₚₗₑ|μ), where μ is a microstate of the system of partitions used to perform the analytical assay (see also FIG. 5b) and respective part of the detailed figure description).

In a preferred embodiment, the number of Epstein-Barr DNA copies is determined using a sample with a volume of 20 μL. The reaction mixture is placed in a system made of PDMS/polycarbonate and 14 droplets on demand with dilution ratios dᵢ=xⁱ, where x=0.5, 86 droplets with x=0.917, and 14 droplets with x=0.5 are generated. The system with droplets is placed in a thermocycler, the PCR reaction is carried out, and subsequently the signals from each droplet (microstate of the system) are read out.

For example, a 20 μL sample containing gene copies at a concentration of Cₛₐₘₚₗₑ-5·10³ mL⁻¹ was used. In five repeated experiments the following results were obtained: in the first trial μ₁={1,1,1,1,1,0,1,0,0,0,0,0,0,0,0,0,0,0,0,0,0,0,0,0,0,0,0,0,1,0,0,0,0,0,0,0,0,0,0,0,0,0,0,0,0,0,0,0, 0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0, 0,0,0,0,0,0,0,0,0,0,0,0,0,0,0}, in the second on μ₂={1,1,1,1,1,1,1,0,0,0,0,0,0,0, 0,0,0,0,0,0,0,0,0,0,0,0,0,0,0,0,0,0,1,0,0,0,0,0,0,0,0,0,0,0,0,0,0,0,0,0,0,0,0,0,0,0,0,0,0,0,0,0,0,0,0, 0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0}, in the third one μ₃={1,1,1,1,1,0,0,1,0,0,0,0,0,1,0,0,0,0,0,0,0,0,0,0,0,0,0,0,0,0,0,0,0,0,0,0,0,0, 0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,00,0, 0,0,0,0,0,0,0,0,0,0,0,0,0,0,0,0,0,0,0,0,0,0,0,0,0,0}, in the fourth one μ₄={1,1,1,1,0,1,1,1,1, 0,0,0,0,0,0,1,0,0,0,0,1,0,0,0,0,0,0,0,0,0,0,0,0,0,0,0,1,0,0,0,0,0,0,0,0,0,0,0,0,0,0,0,0,0,0,0,0,0,0 0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0,0, 0,0,0,0}, in the fifth one μ₅={1,1,1,1,1,0,1,0,0,0,0,0,0,0,0,0,0,0,0,0,0,0,0,0,0,0,0,0,0,0,0, 0,0,0,0,0,0,0,0,0,0,0,0,0,0,0,0,0,0,0,0,0,0,0,0,0,0,1,0,0,0,0,0,0,0,0,0,0,0,0,0,0,0,0,0,0,0,0,0,0,0,0, 0,0,0,0,0,0,0,0,0,0,0,0,0,0,0,0,0,0,0,0,0,0,0,0,0,0,0,0,0,0,0,0}, where the index numbers the repetition of the experiment. Using the statistical model obtained for a given distribution of dilutions, these values are recomputed into the estimates cₗ=Eₗ(Cₛₐₘₚₗₑ) of the initial concentration of DNA copies in the sample c₁=2.30·10³, c₂=6.12·10³, c₃=2.14·10³, c₄=2.90·10³ and c₅=2.30·10³ [mL₋₁].

For example, a 20 μL sample containing gene copies at a concentration of Cₛₐₘₚₗₑ=1.5·10⁵ mL⁻¹ was used. In five repeated experiments the following results were obtained: in the first trial μ₁={1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1,1,1,1,1,1,1,1,1,1,1,1,1,0,1,1,1,1,1,1,0,1,0,1,0,1,0,1,0,1,1,0,1,1,0,1,0,0,1,0,0,0,0,0,0,0 1,1,0,0,0,0,0,0,0,0,0,0,0,0,0}, in the second one μ₂={1,1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,0,1,1,1,1,1,1,1,1,1,1,1,1,1, 1,1,1,1,1,1,1,0,0,1,0,1,0,0,1,0,1,1,1,0,0,1,1,0,0,0,1,0,0,1,0,1,1,0,0,0,0,0,0,0,0,0,0}, in the third one μ₃={1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1,1,1,1,1,1,1,1,1,1,1,1,1,1,0,1,1,1,1,1,1,1,1,0,1,1,1,1,1,1,1,0,1,1,1,1,0,1,0,1,0,1,0,1,0,0,0 1,0,0,1,0,0,0,0,0,0,0,0,0,0,0,0,0,0,0}, in the fourth one μ₄={1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 0,1,1,1,1,1,1,1,1,1,1,0,1,1,0,0,0,1,1,0,1,0,0,0,0,1,0,0,1,0,0,1,0,1,0,0,1,0,1,0,0,0,0,0,0,0,0,0,0,0, 0}, in the fifth one μ₅={1,1,1,1,1,1,1,1,1,1,1,1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,1,1,0,1,1,1,0,1,1,1,1,1,0, 0,1,0,1,1,1,0,0,0,0,0,0,0,1,0,0,0,0,0,1,0,0,0,0,0,0,0,0,0,0,0,0,0}, where the index numbers the repetition of the experiment. Using the statistical model obtained for a given distribution of dilutions, these values are recomputed into the estimates cₗ=Eₗ(Cₛₐₘₚₗₑ) of the initial concentration of DNA copies in the sample c₁=1.45·10⁵, c₂=1.84·10⁵, c₃=1.74·10⁵, c₄=1.43·10⁵ and c₅=1.52·10⁵ [mL⁻¹].

For example, a 20 μL sample containing gene copies at a concentration of Cₛₐₘₚₗₑ=5·10⁷ mL⁻¹ was used. In five repeated experiments the following results were obtained: in the first trial μ₁={1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1,1,0,1,1,0,0,0,0,0,0}, in the second one μ₂={1,1,1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,0,1,0,0,0,0,0,0}, in the third one μ₃={1,1,1,1,1,1,1,1,1,1,1,1,1,1,1,1,1,1,1,1,1,1,1,1,1,1,1,1,1,1,1,1,1,1,1,1 1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1,1,1,0,0,0,0,0,0,0,0}, in the fourth one μ₄={1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1 1,1,1,1,1,1,1,1,1,1,1,1,1,1,1,1,1,1,1,1,1,1,1,1,1,1,1,1,1,1,0,0,0,0,0,0,0,0,0}, in the fifth one μ₅{1,1,1,1,1,1,1,1,1,1,1,1,1,1,1,1,1,1,1, 1,1,1,1,1,1,1,1,1,1,1,1,1,1,1,1,1,1,1,1,1,1,1,1,1,1,1,1,1,1,1,1,1,1,1,1,1,1,1,1,1,1,1,1,1,1, 1,1,1,1,1 1,1,1,1,1,1,1,1,0,0,0,0,0,0,0}, where the index numbers the repetition of the experiment. Using the statistical model obtained for a given distribution of dilutions, these values are recomputed into the estimates cₗ=Eₗ(Cₛₐₘₚₗₑ) of the initial concentrations of DNA copies in the sample c₁=2.84·10⁷, c₂=3.08·10⁷, c₃=3.42·10⁷, c₄=3.81·10⁷ and c₅=3.31·10⁷ [mL⁻¹].

### Executive Example 4

In a preferred embodiment, an inventive quantitation assay for a sample with a volume of 20 μL is designed so as to offer the estimate of the concentration of DNA molecules in the said sample with a relative standard deviation less than σₘₐₓ=15% in the concentration range from C⁻=50 [1/mL] to C^{±}=0.5·10⁷ [1/mL], i.e., (C⁺/C⁻)=10⁵. The required dynamic range is accomplished by partitioning the sample into 474 partitions with dilution degrees

$$\frac{{C}_{n}}{{C}_{sample}} = {d}_{n} = {x}_{n} ,$$

where x=0.9886. Using numerical algorithms presented in the description of the invention one computes a corrected estimate of the initial concentration of molecules in the sample c_{corr}=c·ƒ_{corr}(c), where c=E(Cₛₐₘₚₗₑ) is the estimate of concentration of molecules in the sample, computed using the conditional probability distribution P(Cₛₐₘₚₗₑ|K), where K is a weighted sum of signals from individual partitions counted with weights wₙ=1/dₙ.

So prepared statistical tools (ƒ_{corr}(c) and c(K) functions) can be used to determine the initially unknown concentration of target DNA molecules in the sample.

In a preferred embodiment, the number of Epstein-Barr DNA copies is determined using a sample with a volume of 20 μL. The reaction mixture is placed in a system made of PDMS/polycarbonate and 474 on-demand droplets with dilution degrees

$$\frac{{C}_{n}}{{C}_{sample}} = {d}_{n} = {x}_{n} ,$$

where x=0.9886, are generated. The system with droplets is placed in a thermocycler, the PCR reaction is carried out, followed by counting the signals from each droplet. The signals from droplets displaying high fluorescence level are summed up using weights wₙ=1/dₙ.

For example, a 20 μL sample containing gene copies at a concentration of Cₛₐₘₚₗₑ=5·10² mL⁻¹ was used. In five repeated experiments the following results were obtained: in the first trial K₁=0.178, in the second one K₂=0.404, in the third one K₃=0.292, in the fourth one K₄=0.155 and in the fifth one K₅=0.212, where the index numbers the repetition of the experiment. Using the statistical model obtained for a given distribution of dilutions, these values are recomputed into the estimates of the initial concentration of DNA copies in the sample c₁=8.53·10², c₂=1.56·10³, c₃=1.27·10³, c₄=7.41·10² and c₅=1.02·10³ [mL⁻¹]. After taking the correction into account c_{corr}(c)=c(K)·ƒ_{corr}(c), the following estimates are obtained: c_{corr1}=7.84·10², C_{corr2}=1.43·10³, c_{corr3}=1.17·10³, c_{corr4}=6.80·10² and c_{corr5}=9.32·10² [mL^{-1].}

For example, a 20 μL sample containing gene copies at a concentration of Cₛₐₘₚₗₑ=5·10⁵ mL⁻¹ was used. In five repeated experiments the following results were obtained: in the first trial K₁=54.60, in the second one K₂=59.62, in the third one K₃=58.65, in the fourth one K₄=62.03 and in the fifth one K₅=55.55, where the index numbers the repetition of the experiment. Using the statistical model obtained for a given distribution of dilutions, these values are recomputed into the estimates of the initial concentration of DNA copies in the sample c₁=3.88·10⁵, c₂=4.57·10⁵, c₃=4.38·10⁵, c₄=4.89·10⁵ and c₅=3.94·10⁵ [mL⁻¹]. After taking the correction into account c_{corr}(c)=c(K)·ƒ_{corr}(c), the following estimates are obtained: c_{corr1}=3.99·10⁵, c_{corr2}=4.79·10⁵, c_{corr3}=4.57·10⁵, c_{corr4}=5.17·10⁵ and c_{corr5}=4.05·10⁵ [mL⁻¹].

For example, a 20 μL sample containing gene copies at a concentration of Cₛₐₘₚₗₑₛ=10⁶ mL⁻¹ was used. In five repeated experiments the following results were obtained: in the first trial K₁=74.99, in the second one K₂=78.99, in the third one K₃=77.16, in the fourth one K₄=75.85 and in the fifth one K₅=79.22, where the index numbers the repetition of the experiment. Using the statistical model obtained for a given distribution of dilutions, these values are recomputed into the estimates of the initial concentration of DNA copies in the sample c₁=7.48·10⁵, c₂=8.50·10⁵, c₃=8.06·10⁵, c₄=7.80·10⁵ and c₅=8.55·10⁵ [mL⁻¹]. After taking the correction into account c_{corr}(c)=c(K)·ƒ_{corr}(c), the following estimates are obtained: c_{corr1}=8.62·10⁵, c_{corr2}=1.01·10⁶, c_{corr3}=9.47·10⁵, c_{corr4}=9.09·10⁵ and c_{corr5}=1.02·10⁶ [mL⁻].

### Executive Example 5

In a preferred embodiment of the invention, an assay is designed to offer the estimate of the concentration of DNA particles in a sample with a relative standard deviation less than σₘₐₓ_{₁}=20% in the concentration range from C₁⁻=1 μL⁻¹ to C₁⁺=10³ μL⁻¹, i.e., C₁⁺/C₁⁻=10³, σₘₐₓ_{₂}=10% in the concentration range from C₂⁻=10³ μL⁻¹ to C₂⁺=10⁶ μL⁻¹, i.e., C₂⁺/C₂⁻=10³, and σₘₐₓ_{₃}=20% in the concentration range from C₃⁻=10⁶ μL⁻ to C₃⁺=10⁹ μL⁻¹, i.e., C₃⁺/C₃⁻=10³. The required dynamic range is accomplished by partitioning the sample into a geometric series of N=38 libraries with dilution ratios Cᵢ/C_{S}=dᵢ=xⁱ, where x=0.5 and the first term d₀v₀=11.1 μL, whereas the libraries with indexes from 0 to 9 have cardinalities N′₁=10, the libraries with indexes from 10 to 27 have cardinalities N′₂=40, and the libraries with indexes from 28 to 37 have cardinalities N′₃=10. Using numerical algorithms presented in the description of the invention, the estimate E(Cs) is calculated based on the conditional probability distribution ƒ(C_{S}|μ), where μ is a microstate of the system of compartments used to perform the analytical assay.

The reaction mixture is placed in a system made of PDMS/polycarbonate and N=38 libraries with dilution ratios Cᵢ/C_{S}=dᵢ=xⁱ, where x=0.5, whereas the libraries with indexes from 0 to 9 have cardinalities N′₁=10, the libraries with indexes from 10 to 27 have cardinalities N′₂=40, and the libraries with indexes from 28 to 37 have cardinalities N′₃=10. The system with droplets is placed in a thermocycler, the PCR reaction is carried out, and subsequently the signals from each droplet (microstate of the system) are read out, producing an N-dimensional vector k with coordinates kᵢ equal to the number of droplets belonging to the i-th library, and yielding positive signals.

For example, a sample containing gene copies at a concentration of C_{S}=10² mL⁻¹. In five repeated experiments the following results were obtained: in the first k₁={10, 10, 10, 10, 10, 10, 10, 10, 10, 9, 26, 18, 7, 7, 2, 2, 1, 0, 1, 0, 0, 0, 0, 0, 0, 0, 0, 0, 0, 0, 0, 0, 0, 0, 0, 0, 0, 0}, k₂={10, 10, 10, 10, 10, 10, 10, 10, 10, 10, 9, 25, 18, 7, 4, 2, 2, 1, 0, 0, 0, 0, 0, 0, 0, 0, 0, 0, 0, 0, 0, 0, 0, 0, 0, 0, 0, 0, 0}, k₃={10, 10, 10, 10, 10, 10, 10, 10, 10, 8, 26, 17, 11, 4, 5, 3, 0, 0, 0, 0, 0, 0, 0, 0, 0, 0, 0, 0, 0, 0, 0, 0, 0, 0, 0, 0, 0, 0}, k₄={10, 10, 10, 10, 10, 10, 10, 10, 10, 10, 28, 16, 11, 8, 2, 2, 0, 0, 0, 0, 0, 0, 0, 0, 0, 0, 0, 0, 0, 0, 0, 0, 0, 0, 0, 0, 0, 0}, k₅={10, 10, 10, 10, 10, 10, 10, 10, 10, 10, 25, 14, 11, 8, 3, 0, 1, 0, 0, 0, 0, 0, 0, 0, 0, 0, 0, 0, 0, 0, 0, 0, 0, 0, 0, 0, 0, 0}, where the index numbers the repetition of the experiment. Using the statistical model obtained for a given distribution of dilutions, these values are recomputed into the estimates of the initial concentration of DNA copies in the sample c₁=104±12, c₂=96±12, c₃=104±12, c₄=115+14, and c₅=103±12 μL⁻¹.

For example, a sample containing gene copies at a concentration of C_{S}=10⁵ mL⁻¹. In five repeated experiments the following results were obtained: k={10, 10, 10, 10, 10, 10, 10, 10, 10, 10, 40, 40, 40, 40, 40, 40, 40, 40, 40, 36, 23, 14, 11, 4, 1, 1, 0, 1, 0, 0, 0, 0, 0, 0, 0, 0, 0, 0}, k₂=(10, 10, 10, 10, 10, 10, 10, 10, 10, 10, 40, 40, 40, 40, 40, 40, 40, 40, 39, 34, 27, 16, 9, 4, 2, 3, 2, 0, 0, 0, 0, 0, 0, 0, 0, 0, 0, 0), k₃={10, 10, 10, 10, 10, 10, 10, 10, 10, 10, 40, 40, 40, 40, 40, 40, 40, 40, 40, 34, 24, 20, 8, 3, 3, 1, 0, 1, 0, 0, 0, 0, 0, 0, 0, 0, 0, 0}, k₄=(10, 10, 10, 10, 10, 10, 10, 10, 10, 10, 40, 40, 40, 40, 40, 40, 40, 40, 39, 36, 27, 15, 10, 10, 3, 0, 0, 1, 1, 0, 0, 0, 0, 0, 0, 0, 0, 0), k₅={10,10, 10, 10, 10, 10, 10, 10, 10, 10, 40, 40, 40, 40, 40, 40, 40, 40, 39, 37, 30, 19, 10, 4, 3, 3, 3, 2, 0, 0, 0, 0, 0, 0, 0, 0, 0, 0}, where the index numbers the repetition of the experiment. Using the statistical model obtained for a given distribution of dilutions, these values are recomputed into the estimates of the initial concentration of DNA copies in the sample c₁=(96±10) 10³, c₂=(98±10)·10³, c₃=(99±10)·10³, c₄=(108±11) 10³, and C₅=(123±12)·10³ μL⁻.

For example, a sample containing gene copies at a concentration of C_{S}=10⁸ mL⁻¹. In five repeated experiments the following results were obtained: k₁={10, 10, 10, 10, 10, 10, 10, 10, 10, 10, 40, 40, 40, 40, 40, 40, 40, 40, 40, 40, 40, 40, 40, 40, 40, 40, 40, 40, 10, 7, 8, 2, 1, 2, 1, 0, 0, 0}, k₂={10, 10, 10, 10, 10, 10, 10, 10, 10, 10, 40, 40, 40, 40, 40, 40, 40, 40, 40, 40, 40, 40, 40, 40, 40, 40, 40, 40, 10, 8, 7, 5, 2, 0, 1, 0, 0, 0}, k₃={10, 10, 10, 10, 10, 10, 10, 10, 10, 10, 40, 40, 40, 40, 40, 40, 40, 40, 40, 40, 40, 40, 40, 40, 40, 40, 40, 40, 10, 9, 6, 1, 3, 2, 0, 0, 0, 0}, k={10, 10, 10, 10, 10, 10, 10, 10, 10, 10, 40, 40, 40, 40, 40, 40, 40, 40, 40, 40, 40, 40, 40, 40, 40, 40, 40, 40, 9, 9, 6, 5, 2, 1, 1, 0, 0, 0}), k₅={10, 10, 10, 10, 10, 10, 10, 10, 10, 10, 40, 40, 40, 40, 40, 40, 40, 40, 40, 40, 40, 40, 40, 40, 40, 40, 40, 39, 10, 10, 7, 4, 4, 0, 1, 2, 1, 0}, where the index numbers the repetition of the experiment. Using the statistical model obtained for a given distribution of dilutions, these values are recomputed into the estimates of the initial concentration of DNA copies in the sample c₁=(89±17)·10⁶, c₂=(103±21)·10⁶, c₃=(94±19)·10⁶, c₄=(94±18) 10⁶, and c₅=(104±19)·10⁶ μL⁻¹.

1. A method for determining an estimate of a concentration of particles E(C), wherein a sample of predetermined volume is divided into a number (N) of compartments, at least part of the particles that are present in any of the (N) compartments provide a measurable signal and the estimated concentration of particles E(C) is a function of measured signals, characterized in that the method comprises
a) determining the number (N) of separate compartments, wherein the number (N) is smaller or equal to the value of the function
$${N}_{MAX} = A \cdot ln ( \frac{{C}^{+}}{{C}^{-}} ) / {σ}_{MAX}^{2}$$
wherein (A) represents a real number being the integer 6,
wherein (C⁺) represents a predetermined upper limit of the interval of concentration (C) to be estimated by the method,
wherein (C⁻) represents a predetermined lower limit of the interval of concentration (C) to be estimated by the method,
wherein (σ_{MAX}) represents a predetermined maximum allowable relative standard deviation of the estimate of concentration E(C) of particles, wherein C⁻<C<C⁺, and
b) determining a modulation factor (zᵢ), wherein (zᵢ) is a function of volumes (vᵢ) and dilution factors (dᵢ) of the sample in at least part of or all of the (N) compartments and partitioning the sample into the (N) compartments, wherein at least part of or all of the two or more of the (N) compartments comprise or consist of different sample volumes (vᵢ) and/or different dilution factors (dᵢ) of the sample,
wherein (i) represents an index number of the (N) compartments represented by the integers 0 to N−1, and
wherein (vᵢ) represents the volume and (dᵢ) represents the dilution factor of the sample in the compartment (i).

2. The method according to claim 1, wherein the modulation factor (zᵢ) is determinable by the function zᵢ=(vᵢdᵢ)/(v₀d₀) or analogue thereof, wherein the analogue conveys information about pairwise differences in the estimated number of particles in compartments,
wherein (i), (vᵢ) and (dᵢ) is defined as in claim 1 and
wherein (v₀) represents the volume and (d₀) represents the dilution factor of the sample in a reference compartment, wherein the reference compartment is different to compartment (i), preferably wherein the reference compartment represents the first compartment in the series of (N) compartments.

3. The method according to claim 1, wherein in step b) 1%, preferably 5%, more preferably 25%, even more preferably 50%, even more preferably 75% and most preferably 100% of the (N) compartments differ from each other by the value of the modulation factor (zᵢ).

4. The method according to claim 1, wherein in step b) the value of the modulation factor (zᵢ) is determined based on a well defined power sequence, an exponential sequence, a polynomial sequence or a geometric sequence or based on a distribution in the set of compartments, preferably predetermined by Gaussian distribution or a combination thereof.

5. The method according to claim 4, wherein in step b) the sample is partitioned into (N) compartments with such volumes (vᵢ) and dilution factors (dᵢ) as to fulfil the condition:
(vᵢ₊₁dᵢ₊₁)/(vᵢdᵢ)=zᵢ₊₁/zᵢ=x
wherein x>0 and x≠1, preferably wherein the value of (x) is represented by about 0.1, 0.5, 0.8, 0.9, 0.91, 0.92, 0.93, 0.94, 0.95, 0.96, 0.97, 0.98, 0.99, 1.01, 1.02, 1.03, 1.04, 1.05, 1.06, 1.07, 1.08, 1.09, 1.1, 1.2, 1.3, 1.4, 1.5, 2, or 10 and
wherein preferably quotient x=(vᵢ₊₁dᵢ₊₁)/(vᵢdᵢ) is determinable by the function:
$$x = 1 - {( \frac{{σ}_{max}}{0.8955} )}^{1 / 0.513}$$
the number (N) of compartments is set to an integer not smaller than the value determinable by the function:
$$N = Δ N + {log}_{x} ( \frac{{C}^{-}}{{C}^{+}} )$$
Wherein (ΔN) is an integer not smaller than the value determinable by the function:
ΔN=4.5637(1−x)^{-0.798}
And wherein the value for d₀v₀ is determinable by the function
$${d}_{o} {v}_{o} = ln 2 \cdot {x}^{- Δ N / 2} ( \frac{1}{{C}^{-}} )$$
with (C⁺), (C⁻), (σ_{MAX}), (dₒ) and (vₒ).

6. The method according to claim 1, wherein in step b) the sample is partitioned into (N) compartments with such volumes (vᵢ) as to fulfil the condition: vᵢ=A·exp^{(B·1/N)} wherein (A) and (B) represent independently of each other arbitrary real numbers, and wherein preferably A=1/C⁺ and/or B=[1.95·ln {(C⁺/C⁻)/N}]^{0.856}, wherein the sample is preferably divided into (N) compartments
$$N = 2 \cdot {σ}_{MAX}^{- 1.9} \cdot {( \frac{{C}^{+}}{{C}^{-}} )}^{0.25} , \\ preferably N = 2 \cdot {σ}_{MAX}^{- 1.94} \cdot {( \frac{{C}^{+}}{{C}^{-}} )}^{0.22} .$$
with (C⁺), (C⁻), and (σ_{MAX}) as defined in claim 1.

7. The method according to claim 1, wherein the method comprises the following steps:
c) optionally amplifying the particles of the compartments with one or more suitable reagents and optionally one or more diluents for obtaining a measurable signal indicating the presence of a predetermined threshold number of particles, preferably one, two, three or more particles in a compartment,
d) measuring the signals in each of the (N) compartments and assigning to at least part, preferably all compartments a value (kᵢ), wherein (i) represents the index number of the compartments represented by integers 0 to N−1 and compartment (i) is assigned a first value (kᵢ), if the compartment (i) comprises or consists of the predetermined threshold number of particles or more, and compartment (i) is assigned a second value (kᵢ), if the compartment (kᵢ) comprises or consists of less than the threshold number of particles indicating the first value and
e) determining the estimated concentration of particles E(C), wherein the estimated concentration of particles E(C) is determinable by a function of
i. a sum K of the first and/or second values (kᵢ), wherein the function preferably is corrected using a calibration correction function, and/or
ii. a sum K of weighted first and/or second values (wᵢkᵢ), wherein at least part of the values (kᵢ), preferably each value (kᵢ) is modulated with a weight value (wᵢ), wherein (i) represents the index number of the compartments represented by the integers 0 to N−1, and wherein the weight value (wᵢ) preferably is inversely proportional to the degree of volume and/or dilution of the number (i) of the compartments, and wherein the function is preferably corrected using a calibration correction function, and/or
iii. a number, vector, matrix, tensor of any order or any other unambiguous representation of a microstate μ, wherein the number, vector, matrix, tensor of any order or any other representation comprises or consists of information reflecting at least part of the values (kᵢ) measured in step e), preferably comprises or consists of a vector k≡{kᵢ}, representing the microstate μ, wherein the vector (k) comprises or consists of at least part, preferably all of the values (kᵢ) measured in step e).

8. The method according to claim 1, wherein in step b) the sample is partitioned into a number (N_{LIB}) of two or more separate sets of compartments (libraries), each library set is indexed with (j) and contains Nⱼ′>0 compartments, each compartment in the same library comprising or consisting of a part of the sample volume with the same value of a modulation factor (zⱼ), wherein zⱼ is a function of volumes (vⱼ) and dilution factors (dⱼ) of the sample in the library set (j), and wherein the N_{LIB} separate library sets j are distinguishable from each other by different values of the modulation factor (zⱼ), wherein j represents the index number of the number (N_{LIB}) library sets represented by the integers 0 to N_{LIB}−1, and
wherein preferably the modulation factor (zⱼ) is determined by the function of zⱼ=(vⱼdⱼ)/(v₀d₀) or an analogue thereof, wherein the analogue conveys information about pairwise differences in the estimated number of particles in compartments wherein (vⱼ) represents the volume and (dⱼ) represents the dilution factor of the sample in the compartments of library set (j) and
wherein (v₀) represents the volume and (d₀) represents the dilution factor of the sample in the compartments of a selected reference library set (j).

9. The method according to claim 8, wherein in step b) at least part, preferably all of the number (N_{LIB}) library sets (j) comprise or consist of Nⱼ′=N′ compartments for each library set (j), and fulfil the condition:
(vⱼ₊₁dⱼ₊₁)/(vⱼdⱼ)=zⱼ₊₁/zⱼ=X
wherein x>0 and x≠1 and wherein preferably the function:
$${x}_{max} = 1 - {( \frac{{σ}_{max}}{0.8955} )}^{1 / 0.513}$$
represents the maximum preferred value of the quotient (x), wherein the quotient (x) can be tuned to the technical preferences for execution of the method, and the number Nⱼ′ of compartments in each library set (j) is set to an integer not smaller than the value determinable by the function:
$${N}_{j}^{′} = {( \frac{0.8955}{{σ}_{max}} )}^{2} {( 1 - x )}^{1.026}$$
and the number (N_{LIB}) of the separate library sets (j) is set to an integer not smaller than the value determinable by the function
$${N}_{LIB} = {log}_{x} ( \frac{{C}^{-}}{{C}^{+}} ) + Δ {N}_{LIB}$$
wherein
ΔN_{LIB}=4.5637(1−x)^{-0.798}
and wherein d₀^{j}v₀^{j} is determinable by the function
$${d}_{0} {v}_{0} = ln 2 \cdot {x}^{- Δ N / 2} \cdot \frac{1}{{C}^{-}} .$$
with (C⁺), (C⁻) and (σ_{MAX}), as defined in claim 1 and (d₀) and (v₀) as defined in claim 13.

10. The method according to claim 8, wherein at least part or preferably each of the number (N_{LIB}) library sets (j) is assigned a value (kᵢ^{j}) being a function of at least part of, preferably all the values (kᵢ) assigned to each of the compartments contained in library set (j) in step d), and subsequently mapping the values (kᵢ^{j}) into a number, vector, matrix, tensor of any order or any other unambiguous representation of a microstate μ, wherein the number, vector, matrix, tensor of any order or any other representation comprises or consists of information reflecting at least part of the values (kᵢ^{j}), preferably comprises or consists of a vector k_{LIB}≡{kᵢ^{j}}, representing the microstate μ, wherein the vector (k_{LIB}), wherein the vector (k_{LIB}) comprises or consists of at least part, preferably all of the values (kᵢ^{j}), wherein preferably the value (kᵢ^{j}) comprises or consists of the sum of the values (kᵢ) assigned to each of the compartments contained in library set (j) in step d).

11. The method according to claim 1, wherein the concentration of two or more different particles and/or two or more different parts of essentially the same particles are determined, wherein at least part, preferably all of the different particles and/or different parts of essentially the same particles that are present in any of the (N) compartments provide, preferably are amplified to provide two or more distinguishable measurable signals, wherein the two or more distinguishable signals in any of the (N) compartments are measured and wherein to each of the (N) compartments two or more different values are respectively assigned, wherein the different values independently from each other indicate that a threshold of a number of same particles and/or same parts of essentially the same particles is present in the compartment or not.

12. An apparatus for use in determining a concentration of particles in accordance with claim 1, characterized in that the apparatus is configured to
a) determining a number (N) of separate compartments, wherein the number (N) is smaller or equal to the value of the function
$${N}_{MAX} = A \cdot ln ( \frac{{C}^{+}}{{C}^{-}} ) / {σ}_{MAX}^{2}$$
wherein (A) represents a real number being the integer 6, Wherein (C⁺) represents a predetermined upper limit of the interval of concentration (C) to be estimated by the method, Wherein (C⁻) represents a predetermined lower limit of the interval of concentration (C) to be estimated by the method, Wherein (σ_{MAX}) represents a predetermined maximum allowable relative standard deviation of the estimate of concentration E(C) of particles, wherein C⁻<C<C⁺, and
b) determining a modulation factor (zᵢ), wherein (zᵢ) is a function of volumes (vᵢ) and dilution factors (dᵢ) of the sample in at least part of or all of the (N) compartments so that at least part of or all of the two or more of the (N) compartments comprise or consist of different sample volumes (vᵢ) and/or different dilution factors (dᵢ) of the sample, wherein (i) represents an index number of the (N) compartments represented by the integers 0 to N−1, and wherein (vᵢ) represents the volume and (dᵢ) represents the dilution factor of the sample of predetermined volume in the compartment (i).

13. The use of the method according to claim 1 for
a) reducing the total number (N) of compartments comprising the predetermined sample volume and/or
b) reducing the total volume of a mixture comprising or consisting of sample, one or more reagents suitable for amplifying at least part of the particles to a measurable signal and optionally one or more diluents in all of the (N) compartments and/or
c) predetermining the volume, preferably the minimum or maximum volume of the mixture comprising or consisting of sample, one or more reagents suitable for amplifying at least part of the particles to a measurable signal and optionally one or more diluents in each of the (N) compartments and/or
d) predetermining the modulation factor (zᵢ), preferably the minimum or the maximum suitable modulation factor (zᵢ) for partitioning the predetermined sample volume into the (N) compartments.

14. A sample holder for use in a method for determining a concentration of particles in accordance with claim 1, characterized in that the sample holder is configured to,
a) comprising a predetermined number (N) of compartments wherein the number (N) is smaller or equal to the value of the function
$${N}_{MAX} = A \cdot ln ( \frac{{C}^{+}}{{C}^{-}} ) / {σ}_{MAX}^{2}$$
wherein (A) represents a real number being the integer 6, wherein (C⁺) represents a predetermined upper limit of the interval of concentration (C) to be estimated by the method, wherein (C⁻) represents a predetermined lower limit of the interval of concentration (C) to be estimated by the method, herein (σ_{MA}x) represents a predetermined maximum allowable relative standard deviation of the estimate of concentration E(C) of particles, wherein C⁻<C<C⁺, and
b) wherein the (N) compartments are configured to comprising the predetermined sample volume with a predetermined modulation factor (zᵢ), wherein (zᵢ) is a function of volumes (vᵢ) and dilution factors (dᵢ) of the sample in at least part of or all of the (N) compartments so that at least part of or all of the two or more of the (N) compartments can comprise or consist of different sample volumes (vᵢ) and/or different dilution factors (dᵢ) of the sample, wherein (i) represents an index number of the (N) compartments represented by the integers 0 to N−1, and wherein (vᵢ) represents the volume and (dᵢ) represents the dilution factor of the sample in the compartment (i).

15. A kit comprising the sample holder according to claim 14 and one or more reagents suitable for amplifying at least part of particles comprised in the compartments of the sample holder to a measurable signal and optionally one or more suitable diluents for determining a concentration of particles.

16. The use of the apparatus according to claim 12 for
a) reducing the total number (N) of compartments comprising the predetermined sample volume and/or
b) reducing the total volume of a mixture comprising or consisting of sample, one or more reagents suitable for amplifying at least part of the particles to a measurable signal and optionally one or more diluents in all of the (N) compartments and/or
c) predetermining the volume, preferably the minimum or maximum volume of the mixture comprising or consisting of sample, one or more reagents suitable for amplifying at least part of the particles to a measurable signal and optionally one or more diluents in each of the (N) compartments and/or
d) predetermining the modulation factor (zᵢ), preferably the minimum or the maximum suitable modulation factor (zᵢ) for partitioning the predetermined sample volume into the (N) compartments.

17. The use of the kit according to claim 15, for determining an estimate of a concentration of particles E(C), wherein a sample of predetermined volume is divided into a number (N) of compartments, at least part of the particles that are present in any of the (N) compartments provide a measurable signal and the estimated concentration of particles E(C) is a function of measured signals, characterized in that the method comprises
a) determining the number (N) of separate compartments, wherein the number (N) is smaller or equal to the value of the function
$${N}_{MAX} = A \cdot ln ( \frac{{C}^{+}}{{C}^{-}} ) / {σ}_{MAX}^{2}$$
wherein (A) represents a real number being the integer 6,
wherein (C⁺) represents a predetermined upper limit of the interval of concentration (C) to be estimated by the method,
wherein (C⁻) represents a predetermined lower limit of the interval of concentration (C) to be estimated by the method,
wherein (σ_{MAX}) represents a predetermined maximum allowable relative standard deviation of the estimate of concentration E(C) of particles, wherein C⁻<C<C⁺, and
b) determining a modulation factor (zᵢ), wherein (zᵢ) is a function of volumes (vᵢ) and dilution factors (dᵢ) of the sample in at least part of or all of the (N) compartments and partitioning the sample into the (N) compartments, wherein at least part of or all of the two or more of the (N) compartments comprise or consist of different sample volumes (vᵢ) and/or different dilution factors (dᵢ) of the sample,
wherein (i) represents an index number of the (N) compartments represented by the integers 0 to N−1, and
wherein (vᵢ) represents the volume and (dᵢ) represents the dilution factor of the sample in the compartment (i).
